(19) United States
(12) Patent Application Publication
(10) Pub. No.: US 2010/0179860 A1
(43) Pub. Date: Jul. 15, 2010

(54) CUSTOMER RELATIONSHIP MANAGEMENT SYSTEM

(76) Inventors: Nicolas Noel, London (GB); Stephane Janisson, London (GB)

Correspondence Address: LANDO & ANASTASI, LLP, ONE MAIN STREET, SUITE 1100, CAMBRIDGE, MA, 02142, US

(21) Appl. No.: 12/523,303

(22) PCT Filed: Jan. 21, 2008
(86) PCT No.: PCT/GB2008/000194

§ 371 Date: Feb. 1, 2010

(30) Foreign Application Priority Data
Jan. 19, 2007 (GB) 0701078.8
Apr. 12, 2007 (GB) 0707100.4

(51) Int. Cl. G06Q 30/00; G06Q 10/00; G06F 17/30; G06F 21/00

(52) U.S. Cl. 705/10; 707/754; 726/1; 707/E17.059

(57) ABSTRACT

Embodiments of the present invention provide a CRM system for use by a plurality of users. The system includes a plurality of client profiles comprised of general data profiles and product-specific profiles, each comprising a plurality of data parameters. Each client profile template is owned by an administrator. Each product-specific profile is owned (across a given client profile template) by a given product specialist. Each data parameter has a plurality of data values assignable to it and each user has access to at least some of the data parameters for a (non confidential) client profile and is authorized to modify the data value assigned to the data parameter to which he has access. The modified data values can be stored as temporary data for that client profile. At least one user can still directly edit new data values and validate existing temporary data values as updated data values.

### FIELD OF THE INVENTION

This invention relates to Customer Relationship Management (“CRM”) systems and in particular to CRM systems of the type which may be used by financial institutions such as investment and commercial banks, and insurance companies, and more broadly by knowledge workers.

### BACKGROUND TO THE INVENTION

The main challenge of modern financial industry consists in marketing efficiently an increasingly wide, complex and context-specific range of financial products, with each of those divided into several sub-products (each a “Product” and “Sub product”), to an increasingly numerous, diversified and fast-evolving range of clients, the latter consisting of individuals, corporations, financial and public institutions of any size, which may be spread over numerous countries or be otherwise geographically diverse (each a “Client”). This organizational challenge is a well-publicized problem in financial institutions, such as banks and insurance companies (the “Financial Institutions”), but, it also affects other sectors, particularly those employing mostly knowledge workers, such as law firms, consulting firms, or healthcare-related and other service industries.

To market their products, Financial Institutions mostly employ two categories of employees: (i) the “Product Specialists”, who master in great detail a limited range of Products and/or Sub-products (generally 5-20); and (ii) the “Coverage Persons” (who together with the Product Specialists, and other staff in the risk department, sectorial and country analysts, management and support staff comprise the “Users”), who are responsible for a dedicated portfolio of Clients (generally 10/+) active in a few sectors.

The Product Specialists rely to a very large extent on the pre-screening of business opportunities carried out by the Coverage Persons to determine whether or not a selling opportunity exits. In an efficient Financial Institution, the former should only really get engaged into a sustained business dialogue with a Client when there are factual reasons to believe that this will lead to the actual sale of a Product or a Sub-product. This decentralized pre-screening requires the Coverage Persons to know enough of each Product's and Sub-product's characteristics and in particular of the key factors influencing a Client's preference for a Product or Sub-product (the “Screening Criteria”).

Unfortunately, the last 10 years have seen an “Informational Gap” growing rapidly between Coverage Persons and Product Specialists. The Products and Sub-products are simply becoming too numerous, too complex and the Screening Criteria tend to be less straightforward and increasingly multi-dimensional and context-specific. This is in addition to a fast-changing economic, legal, tax and regulatory environment. For instance, in a Financial Institution there may be 50 largely different Products (sub-divided in an aggregate of 200/+ Sub products), and no Coverage Person can realistically keep himself/herself abreast of all evolutions of these. Cultural factors also play their part; bank employees are mostly bonus-driven and are not born team players. To the contrary, they usually are reluctant to share information and adopt collaborative behavior. Even though the most successful banks are those which actively encourage cross-selling and team work, overall progresses in the collaborative field have been disappointing.

As a result of this Informational Gap, resources and business opportunities are routinely wasted and lost on a wide scale. Existing CRM systems have tried to address the Informational Gap, but they suffer from several severe limitations.

Most CRM systems focus exclusively on keeping an up-to-date repository of Clients' contact details, and keeping track of the past and on-going marketing interactions with Clients. For those CRM systems which go beyond this business cards & call reports basic level, and do include some form of Client Profile data concept, the Client Profile tends to be rather superficial, not fully scalable, very static, not contextual and does not promote collaborative behavior within the Financial Institutions. Each of these five limitations is in turn detailed hereafter:
(i) Superficial, because the Client Profile data is generally organized over only one or two levels, rather than being systematically layered into as many levels as required, reflecting each Product complexity and context-specific nature (E.g. general data level first, then Product-specific data level, then Sub-product data level, etc), as well as each Client own degree of complexity (size, geographical and/or activity footprint, regulated environment . . . ). This lack of (or very limited) layering means that there is no systematic and gradual “zoom process”, a process whereby the number, and the degree of precision and technicity of the questions logically increase with the identified likelihood that there be effectively an actual opportunity for a specific Product or Sub-product. For lack of an understandable (logical) step-by-step zoom process, most CRM-users tend not to bother filling in the required data fields, unless being forced to;
(ii) Not fully scalable, because there is usually a small number of “Client Profile Templates” which cannot be easily used to generate—once fine-tuned—a virtually infinite series of families of Clients, one tailor-made for each type of Clients (E.g.: one template for a standard corporate, but also others—with some variations—for trading companies, leasing companies, transportation companies, etc). As a result, the Client Profile Templates are perceived by Users as being remotely relevant for most of their non-standard (and often most valuable) Clients. Client Profile Templates are predefined sets of parameters used to identify risks and opportunities with respect to particular clients. A new Client will be assigned a particular template.
(iii) Very static, because the Screening Criteria for Clients can't directly and easily be amended/fine-tuned by the Users themselves, but only through professional internal or external software developers. This limitation in itself explains why the CRM systems are never regarded by Users as truly up-to-date and business-relevant, and why appropriation by Users remains quite limited. In particular, the adoption of the CRM tools by the most senior Users has been quite limited so far (apart from periodically receiving system-generated aggregate reports);
(iv) Not contextual: The traditional CRM rarely links the CRM entries (E.g. the word “Ebitda” or anyother accounting/tax/legal entries, but also entries on a given country or sector) with an in-house intranet encyclopaedia (using a wiki platform) which allows knowledge workers to efficiently and contextually share their knowledge. Also, the links between traditional CRM and credit processes are often very limited (E.g. no hyperlinking between an entry/name as it appears in the CRM “silo”, and the same entry in a credit application or in the yearly review of the marketing strategy for a given Client). The CRM does not leverage the Financial Institution's overall knowledge. In turn, the central repository of information (when it exists) is much less kept up-to-date by employees, since its pay-back in the context of daily transactions (I.e. when it matters most) is much less obvious.
(v) Not promoting cooperative behavior, because these CRM systems do not include enough “virtuous circles” whereby Users are systematically incentivized to contribute their proprietary know-how, for instance with respect to what they regard as the most efficient Screening Criteria for a given Product. Users do not co-operate fully because they do not feel that the CRM system is giving them in return significantly more added value than each of them contributes: the limited pay-back is insufficient to compensate Users for their time spent and for what they perceive as their loss of “proprietary information”. In such context, Users tend to limit their contribution to what is compulsorily required from them. The CRM is viewed as a constraint rather than as a chosen tool, its perceived pay-back for most Users remains relatively low.

While some CRM systems have tried to tackle some of the above five limitations, none has so far developed a methodology systematically tackling all five, in a seamlessly and synergetic manner.

### SUMMARY OF THE INVENTION

The present invention is a comprehensive Client-facing Information System which brings traditional CRM to the next level by seamlessly and synergetically blending (i) the extensive functional possibilities offered by web 2.0 collaborative technologies, with (ii) an innovative methodology specifically designed to foster collaborative behavior between knowledge workers.

Based on our User experience and research, we believe that—beyond using web 2.0 collaborative technologies—an efficient CRM system must meet all of the following specifications:
(i) It MUST be part of a wider holistic Client-facing Information System which must also include an extensively interfaced series of topical Profiles on products, sectors, countries, as well as embedding some other non-CRM processes, such as periodic marketing reviews, and ideally credit applications; AND
(ii) It MUST also address ALL of the five limitations described above, as the failure to tackle in a synergetic manner even a single of the five issues would severely reduce the System's overall pay-back for Users.

The invention is a “System” in that its components can't be dissociated or analyzed separately. In essence a CRM, must be part of an eco-system made of inter-acting modules designed ex ante to optimize such interactions.

The present invention is embodied as a web-based three-tier database (the “Application” or “System”, and the “Database”). The Application allows Users to set up for each Client, to keep up to date and to constantly contribute information to, and refine over time, a “Client Profile”. Such Client Profile consists of a series of computer screens (each a “Screen”) organized into two types of Screens: (i) the “General Dimension Screens” describing non-product specific characteristics of the Client, such as its financial statements, activity, shareholders, or exposure to various types of risks; and (ii) the “Product Screens” containing the data needed to analyze the Client's need for that Product, this Product being then sub-divided into Sub-products (themselves described in Sub-product Screens). There can be as many Product, Sub-product, Sub-sub-products, etc, levels as requested by each business line. The Application comprises software which runs the Database.

In accordance with one aspect of the present invention there is provided a customer relationship management (CRM) system for use by a plurality of users, the system comprising a plurality of client profiles (organized by client families, containing clients of a similar nature), these client profiles comprising their related General Dimension Screens and Product Screens, each Screen comprising a plurality of data parameters, each data parameter having a plurality of data values assignable to it, each user having access to at least some of the data parameters (for a non-confidential client profile) and being authorized to modify the data value assigned to a data parameter to which that user has access, and wherein that user can save any modified data values as temporary data for that client profile whereby the modified data values are made available to other users, and wherein at least one user can store modified data values directly as updated data values for a data parameter.

In accordance with another aspect of the invention, there is provided a CRM system for use by a plurality of users, the system comprising a plurality of client profiles and product profiles, each product profile comprising a plurality of data parameters, each data parameter having a plurality of data values assignable to it, each user having access to at least some of the data parameter to which that user has access, and wherein that user can save any modified data values as temporary data for that product profile and at least one user can store modified data values as updated data values for data parameter.

Preferably at least one of the data parameters assigned to a client profile has a criticality mark assigned to it. The criticality marks are designed to attract users' attention onto the most useful data parameters to be filled in (for instance because these data parameters are used in risk and/or opportunity scores, each as defined below).

Preferably at least one of the data parameters has a risk score or an opportunity score associated with it.

Preferably the system includes means for deriving a total risk score from all the risk scores associated with data parameters for a particular client profile, such total risk score calculation being made (i) in aggregate across the set of General Dimension Screens; and (ii) as may be needed, independently for each Product or Sub-product Screen.

Preferably, the system includes means for deriving a total opportunity score from all the opportunity scores associated with data parameters for a particular client profile, such total opportunity score calculation being made (i) in aggregate across the set of General Dimension Screens, and (ii) independently for each Product or Sub-product Screen.

Preferably the system includes means for visualizing for a particular client profile—through a dedicated Client roadmap screen—(i) the aggregate opportunity score and the aggregate risk score across the set of General Dimension Screens, as well as (ii) the opportunity—and as may be needed the risk—scores for each product/sub-product.

Preferably the system includes means for deriving a total risk score from all of the risk scores associated with data parameters for a particular client profile.

Preferably each client profile contains data parameters associated with non-product specific characteristics of that client (in the General Dimension Screens) and data parameters associated with at least one product which may be sold to that client (in the Product Screens).

A data parameter may be modified from any of the different screens where the said data parameter appears.

Preferably a total risk score is derived each time a general dimension screen is viewed.

Preferably a total opportunity score is derived each time a general dimension screen is viewed.

Preferably a total opportunity score is derived each time a product screen is viewed.

Preferably a total criticality score is derived each time a general dimension screen is viewed.

Preferably a total criticality score is derived each time a product screen is viewed.

Preferably the system includes means to filter (i) opportunity scores associated with products and opportunity, and (ii) risk scores associated with clients' general dimensions, in order to determine which products are best suited to a particular client, and which clients display the most/least attractive risk-reward ratio.

Preferably, each product/sub-product profile contains a subsidiary profile containing data parameters associated with transactions related to the said product/sub-product that have been executed. Such Benchmark & Credentials screen (i) is interfaced with the Closed Deals tab(-s) of the relevant Opportunity Profile(-s), and (ii) contains a series of topical sections describing what the User should know regarding the Product characteristics and usage, the risks both for the Client and for the Financial Institution, the structuring process and the profitability for the Financial Institution.

Preferably, each of the general dimension screens and product/sub-product screens in the client profile comprises a subsidiary profile offering users the possibility to edit free text information with respect to the relevant screen topic.

Preferably, the system further comprises a screen containing client marketing strategy information, such screen being accessible from any screen of the Client Profile. Such a module—called Client Action Plan—allows a periodic review (E.g. every 6 or 12 months) by a group of users of the Financial Institution's strategy with respect to a given Client and for a broad range of products, using peer group benchmarks (I.e. transactions closed by similar Clients). The Client Action Plan is organized in topical sections (E.g. shareholders, activity, rating and funding costs, . . . ), each section being extensively hyperlinked with the relevant screen and relevant data parameters in the relevant client profile.

Preferably, each client profile contains data parameters associated with transactions that the client has executed or is executing. These data related to opportunities & marketing actions are each interfaced with the relevant opportunity profile(-s) and/or the relevant marketing action(-s).

Preferably, the system further comprises an Opportunity Profile containing information in relation with a specific opportunity, such Opportunity Profile being organized in several sub-screens: (i) the Key Data screen, on the Opportunity's key steps displayed in a timeline—including the Marketing Actions in relation to such Opportunity, such as meeting call reports and phone logs, the risk and profitability attached to the Opportunity; (ii) the Opportunity Team and Contacts with the Client(-s); (iii) the Key Drivers, a series of decision-drivers interfaced with the Client Profile, such drivers data parameters ceasing to be interfaced and being then frozen when the opportunity is closed; as well as—when the Opportunity is closed (iv) the details of the transaction, such as bond/loan tranches placed with investors/lenders.

Preferably, the system further comprises (i) for each User, a “User Profile”, and (ii) for each Contact Person, a “Contact Profile”. The User Profile (FIG. 19.1) contains for each User (i) the relevant contact details, (ii) matrix of responsibilities in terms of clients, contacts, groups, countries and sectors covered, (iii) centers of interest, and (iv) access rights to various profiles and data present in the system. The Contact Profile (FIG. 19.2) contains for each external Contact (i) the relevant contact details, (ii) the Marketing Actions and Opportunities relating to such Contact; and (iii) the Users covering such Contact.

In one embodiment, the system further comprises means for displaying contextually-targeted advertisements, news and other messages to a User when the User is viewing a given client profile screen, such advertisements, news and other messages reflecting (among others) the client's name, its sector and/or nationality, and/or the specific product being considered. The same feature appears in the other profiles (Sector, Country, User/Contacts, Opportunities and Marketing Actions . . . ).

In accordance with another aspect of the invention, there is provided a Customer Relationship Management (CRM) system comprising a plurality of client profiles (each made of general dimension screens and of product/sub-product/etc screens), each client profile comprising a plurality of data parameters, each data parameter having a plurality of data values assignable to it, each client profile having at least one coverage person authorized to validate data values assigned to data parameters, each product profile having a plurality of data parameters, each data parameter having a plurality of data values assignable to it, each product profile having a product specialist authorized to modify data parameters.

Preferably, each data parameter in a client profile template can be assigned a criticality, opportunity and/or risk score. Such scores are assigned (i) for each product/sub-product screen by the product specialist owning such screen; and (ii) for the general dimension screens by the owner of the client profile template. Any data parameter used in an Opportunity Score or a Risk Score automatically receives a high criticality level.

Preferably, each data parameter in a client profile template can be assigned a confidentiality level by the client profile owner.

In accordance with another aspect of the invention, there is provided a method for operating a Customer Relationship Management (CRM) system for use by plurality of users comprising the steps of: creating a plurality of client profiles and product profiles, each client profile comprising a plurality of data parameters, each data parameter having a plurality of data values assignable to it; permitting each user to access at least some of the data parameters for a client profile and to modify the data value assigned to these, storing such modified data values as temporary data; and permitting at least one user to permanently store temporary data as validated data.

In accordance with another aspect of the invention, there is provided a method for operating a Customer Relationship Management (CRM) system comprising a plurality of client profiles comprising the steps of creating a plurality of client profiles, each client profile comprising a plurality of data parameters, each data parameter having a plurality of data values assignable to it, designating the creator of the client profile as a coverage person authorized to validate data values assigned to the data parameters, each product profile having a plurality of data parameters, each data parameter having a plurality of data values assignable to it, each product profile having a product specialist authorized to assign data parameters to the product profile, permitting any user to make temporary modifications to data values assigned to data parameters in the client and product profiles and permitting only the coverage person to validate these modifications.

### BRIEF DESCRIPTION OF DRAWINGS

Preferred embodiment of the invention will now be described in detail by way of example with reference to the accompanying drawings in which:

FIG. 1: Homepage for the InfoSystem with the 3 Menus (in the middle the “classical menu”, above the “drop-down menu”, and to the left the “side menu”).

FIG. 2: A “Client Profile screen” as displayed to a user. The screen presented is the “Key Data” screen which displays the main information in relation to a Client. The screen shot in the upper part of this page displays the screen when in “Edit mode”.

FIG. 3 shows the Fully Scalable Properties of the System.

FIG. 4 shows the Relationship between Coverage Persons, Product Specialists, Country and Sector Specialists.

FIG. 5a-e shows an example of a “Tree Structure” combining General Data Screens and Product Screens with some corresponding Sub-product screens.

FIG. 6 shows the screen displayed to enable a user to “Create a New Client Profile”.

FIG. 7 shows in a Client Profile the “Coverage Screens” comprised of the “Contacts Coverage” (which shows the Contact Persons at the Client and who covers them) and the “Bank Relationship” (which shows the Bank's employees covering such Client).

FIG. 8 shows in a Client Profile how to Edit the Contacts Coverage screen and replace a User.

FIGS. 9.1 to 9.7 show a number of Client Profile screen shots for General Data Screens and for Product Screens.

FIG. 10 shows a screen shot for a “Client Profile Template” where the Confidentiality status, the Risk Score and the Opportunity Score can be modified.

FIG. 11 shows a pop-up window accessed from the Client Profile Template to edit the Risk Score, the Opportunity Score, the Criticality mark and the Confidentiality mark.

FIGS. 12.1 to 12.4 shows various screen shots related to “Opportunity Profiles”.

FIG. 12.1 shows the screen to “Create an Opportunity”.

FIG. 12.2 shows the “Opportunity Profile” opened at the “Key Data” tab.

FIG. 12.3 shows the “Opportunity Profile” opened at the “Opportunity Team and Contacts” tab.

FIG. 12.4 shows the “Opportunity Profile” opened at the “Closed Deal” tab.

FIG. 13 shows a screen shot of an “Awards, Benchmarks & Credentials” Profile.

FIG. 14: shows a screen shot of “Client Action Plan”.

FIG. 15: shows a screen shot of “Peer Group”.

FIG. 16: shows a screen shot of “Create Call Report”.

FIG. 17: shows a screen shot of “Create Phone Log”.

FIG. 18 shows a screen shot for “User Profile Access Rights”.

FIG. 19.1 shows the “User Profile/Contact Details” screen.

FIG. 19.2 shows the “Contact Profile/Contact Details” screen.

FIG. 20 shows in a User Profile the “User's Matrix of Competencies”.

FIG. 21 shows in a User Profile, the User's “Centers of Interest”, and how to select those.

FIG. 22: shows a screen shot of “Client Profile Advanced Search”.

### DETAILED DESCRIPTION OF PREFERRED EMBODIMENT

Users interact with CRM systems via computer terminals and data relating to the CRM system will be displayed in a user's computer screen. Embodiments of the present invention and their operation can most easily be understood from a description of the interaction of users with the CRM system via their computer screens. This will show how data stored in the database of the CRM can be accessed and modified and how embodiments of the invention overcome the problems of prior art systems.

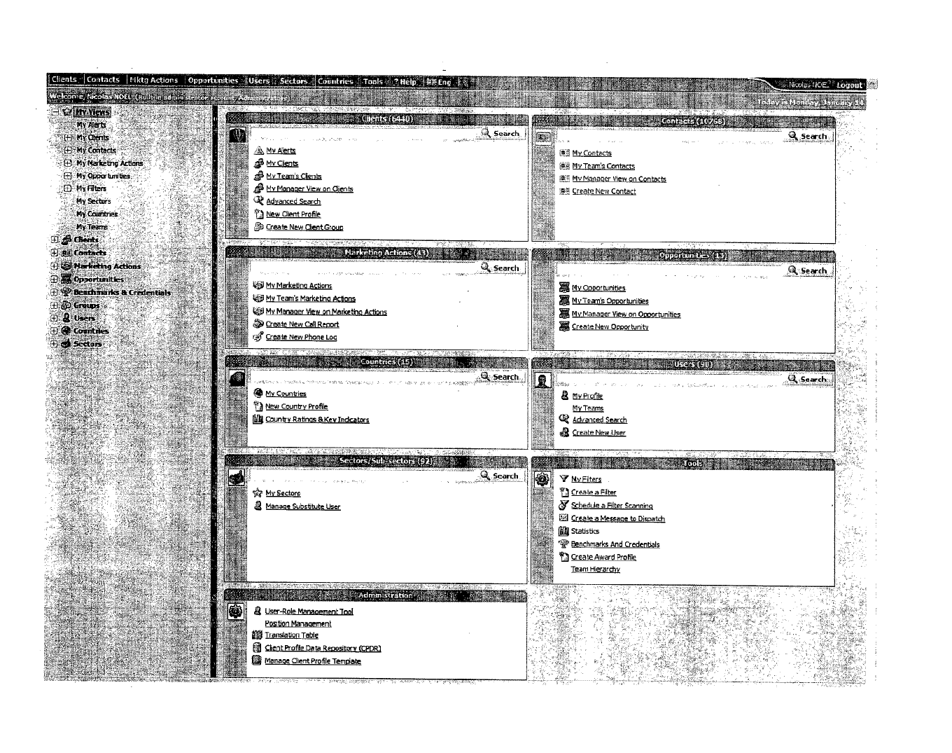

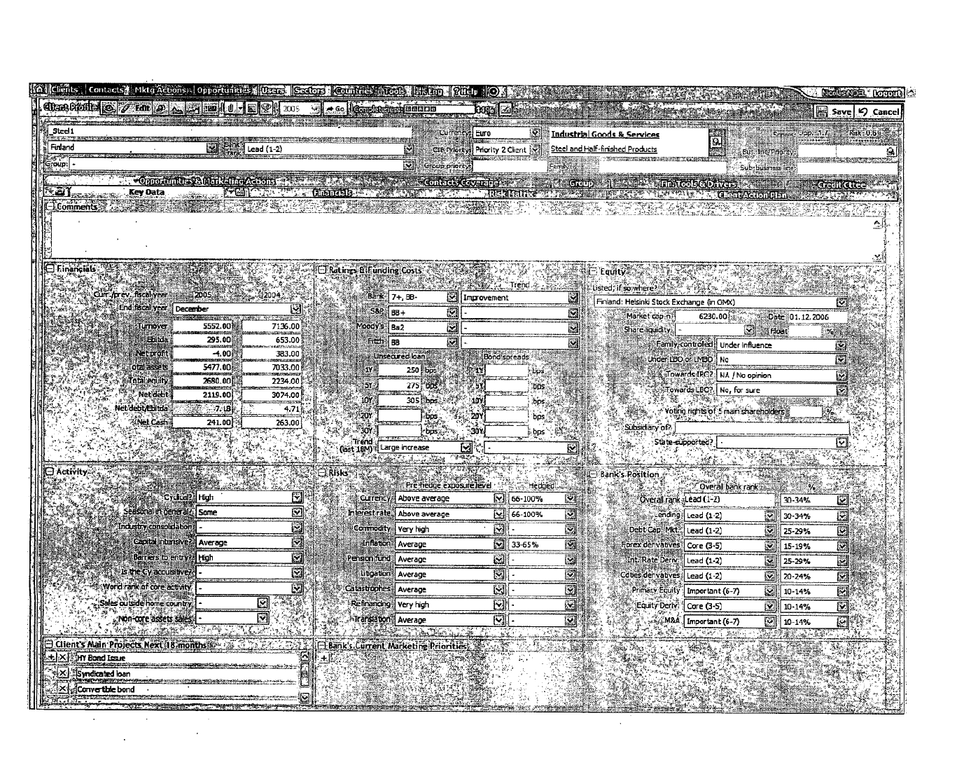

The InfoSystem's functionalities can be easily accessed by Users from any of three types of menus (refer FIG. 1): (i) the “Classical Menu” screen which occupies the centre of the Dashboard/Menus screen; (ii) the “Application Menu Bar” which is displayed on the very top of each screen within the Application, and gives access to drop-down lists; or (iii) the “Side Menu”, a panel displayed on the left of most screens, which can be easily folded/unfolded by Users, and within which each section can also be folded/unfolded to give access to more functionalities. In each of these three Menus, the functionalities are gathered in topical categories (E.g. Views, Clients, Users, Contacts, Marketing Actions, Countries, Sectors . . . ).

The Profile of a particular Client may be located and accessed either through (i) the Standard/Advanced Search functions, or (ii) by selecting “My Clients” from one of the three Menus (from “My Work” in the Side Menu, from the “Clients” drop-down in the Application Menu Bar, and from the “My Clients” section in the Classical Menu).

A Client Profile will typically comprise a number of different screens which a User can view/edit when obtaining information about that client.

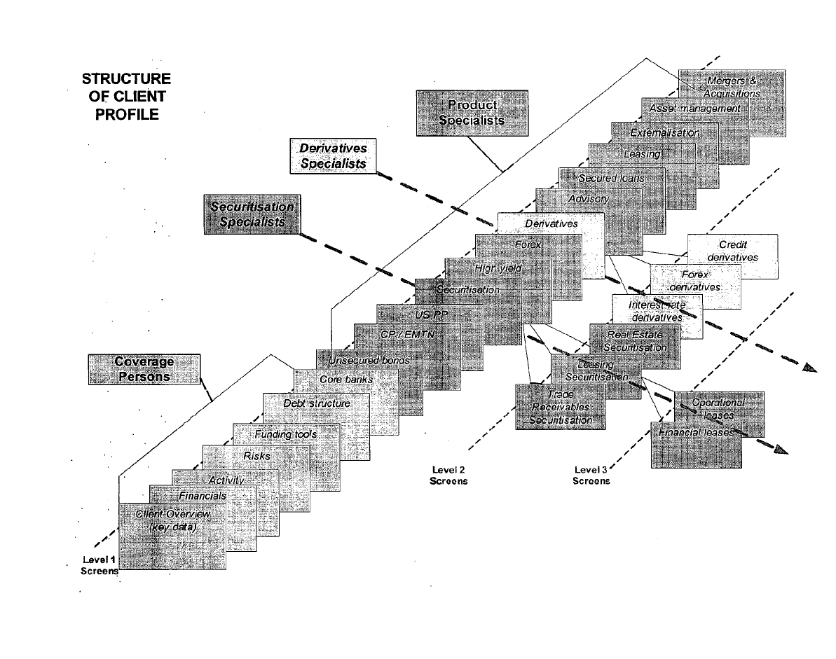

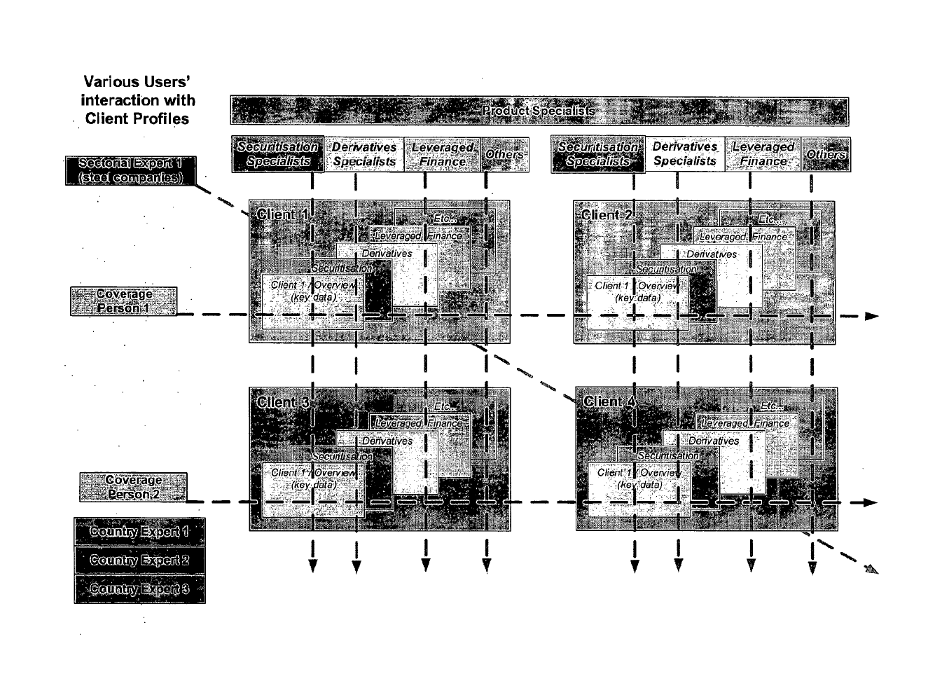

Each single Data Parameter corresponds to a “Data Field” stored in the Database in which appears—once selected—a “Data Value” which can be one of two types: a “Quantitative Data” value (E.g. a figure or a percentage) or a “Qualitative Data” value (E.g. a word or a sentence). While most Data are organized linearly (i.e. to one Data Parameter corresponds one Data Field), some reference tabular data included in tables (e.g. list of equity holdings owned by the Client), with some of these tables making use of vertical and/or lateral scroll lists. An example of such Screen, is shown in FIG. 2. This is the “Key Data Screen”, which is itself part of the General Data Screens in the Client Profile. Preferably, throughout the System, priority is given to Qualitative Data over Quantitative Data, because experience tells that the former are at least as important Screening Criteria as the latter, are definitely more difficult to collect from the Coverage Person's standpoint, and constitute key building blocks in allowing the Financial Institution to gain a competitive advantage.

For each Screen, in a Client Profile each Data Value can be edited by any User who has successfully logged into the System, and provided such User has Access Rights (as defined below) to the said Data Field. This is the opposite of the business rule typically enforced by existing CRM systems in which edit rights are the preserve of only a few designated Users (typically just the Coverage Persons and Product Specialists who are directly covering the given Client) or the Overall Administrator (as defined below). The CRM system embodying the present invention seeks to optimize the balance between, on the one hand, an updated database (where many Users can collaboratively edit) and, on the other hand, a database containing accurate data (where editing still remains controlled, even if on an ex post basis). This is achieved through the combination of the following two business rules:
(i) any User can edit “Temporary Data” in a Data Field (provided the User has access to the said Data Field).
(ii) for each Screen of each Client Profile there is only one “Authorized User” designated in the CRM system (the “Screen Owner”). The Screen Owner may designate “Substitute Users” who are allowed to validate Temporary Data and to henceforth transform them into “Validated Data”. Preferably, each User can view for each Data Field in the System whether it is storing Temporary Data or Validated Data, which User has edited/validated it, and when. Furthermore, preferably for each Data Field, an “Audit Trail” allows each Screen Owner to view all or part of the saved prior versions of the Data. The Audit Trail allows the Screen Owner to manually revert to the last Validated Data and—if deemed necessary—to erase any Temporary Data which has been added or edited since the last Validated Data.

In summary, the business logic embodied in the present invention corresponds to a highly decentralized editing system, but with several strong safety net mechanisms.

For each Data Value, the User can either (i) select a Data Value from a “Drop-down List”, itself consisting of a series of “Data Values”, or (ii) type in a free text, which can consist of a figure, a word or a sentence (a “Free Text”). Throughout the System, whenever possible, priority is given to using Drop-down Lists, as opposed to Free Text, to ensure that the Data accumulated in the System are subsequently easily searchable via Simple Search and Advanced Search functions (each as described below).

For illustrative purpose, a Data Parameter can be: “Is the Client in a cyclical sector of activity?”. The corresponding Drop-down List can offer Users several choices: “Yes, a lot”, “Yes, some”, “Unknown”, “Not much” or “Not at all”. Likewise, the Data Parameter could relate to the Client's financial statements, for instance to the “Client's turnover”, the Data Field being here a Free Text in which the User is expected to type in a figure (e.g. 780 MUSD).

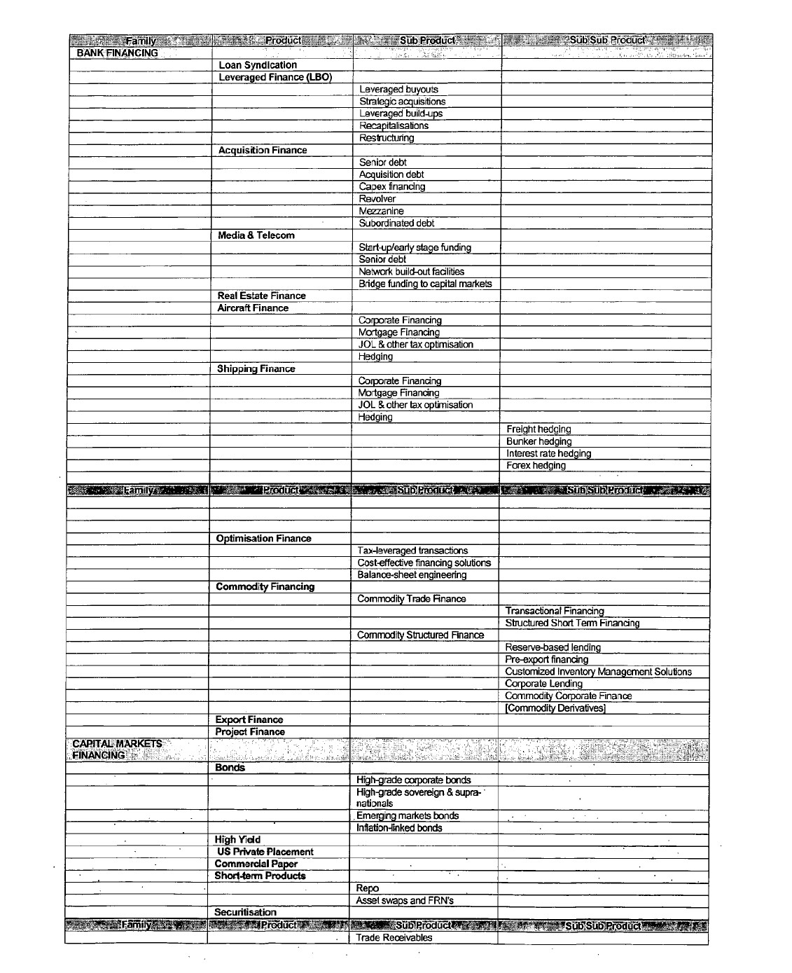

As shown in FIG. 3, each Client Profile consists of two types of Screens. These are:
(i) “General Data Screens” which refer to a series of Screens—typically around 15—with each focusing on a specific aspect/dimension of the Client, for instance the Equity Screen or the Ratings & Funding Costs Screen; and
(ii) “Product Screens” which refer to a series of Screens—typically 20-40—with each focusing on a specific Product. When a Product is sub-divided in several Sub-products (E.g. a Securitization product is divided into Trade Receivables Securitization, Mortgages Securitization, Leases Securitization, Real Estate Securitization, . . . ), each of these Sub-products has a specific tailor-made Screen which is accessible via the relevant Product Screen.

FIG. 3 also shows the fully scalable properties/structure of the System.

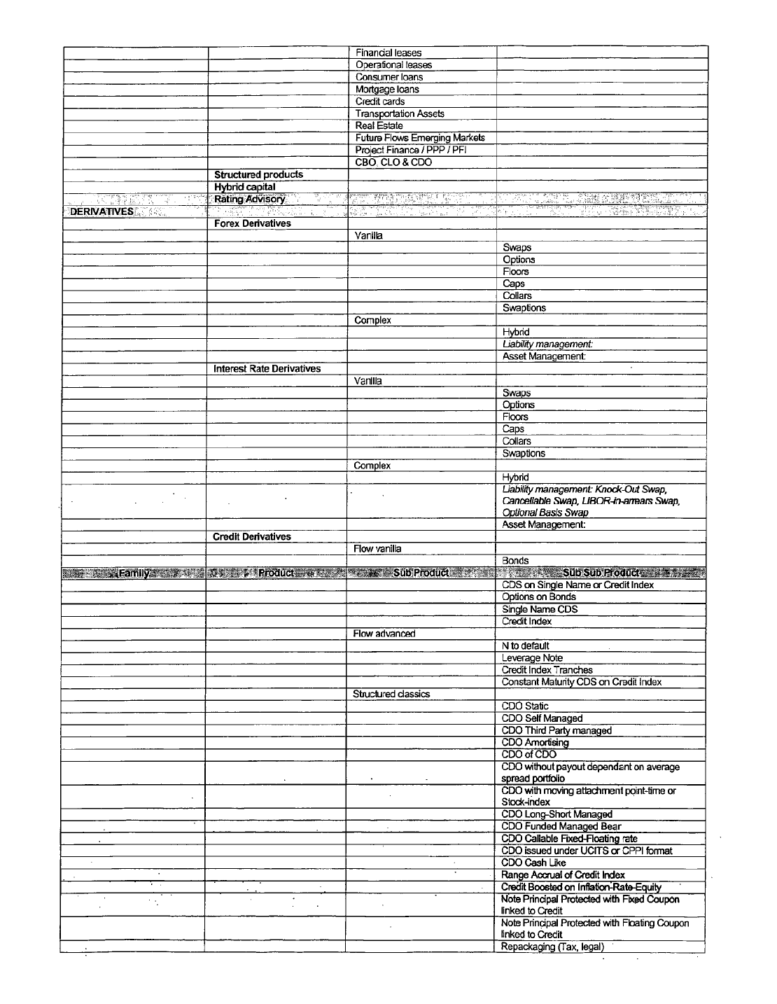

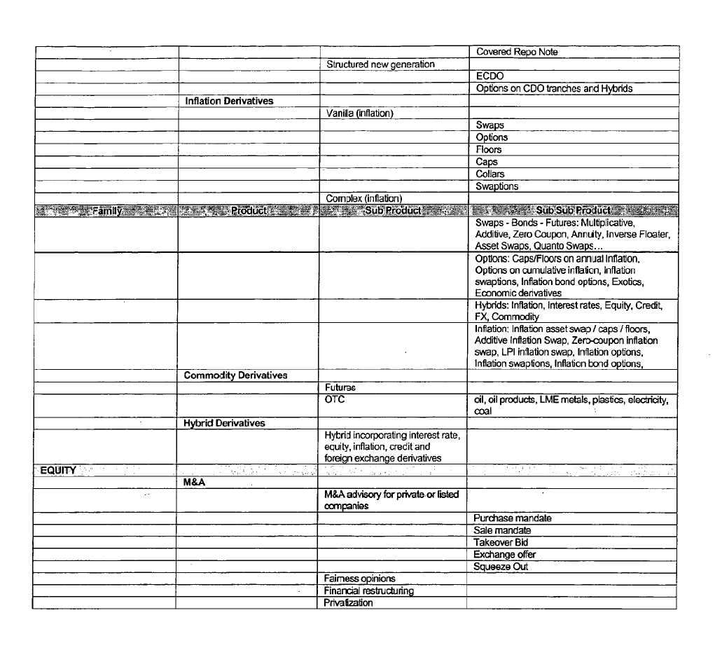

FIG. 4 shows how the System facilitates the inter-actions between Coverage Persons and Product Specialists, but also (among others) between Country Specialists and Sectorial Experts. These various Users can collaboratively and over time build a Client Profile, their team work being greatly facilitated by the decentralized ownership of (i) the Client Profile structure, owned by the Client Profile Template Administrator, (ii) the Product/Sub-product screens, owned by a Product Specialist, but also (iii) the Country Profiles and Sector Profiles, respectively owned by Country and by Sector Specialists.

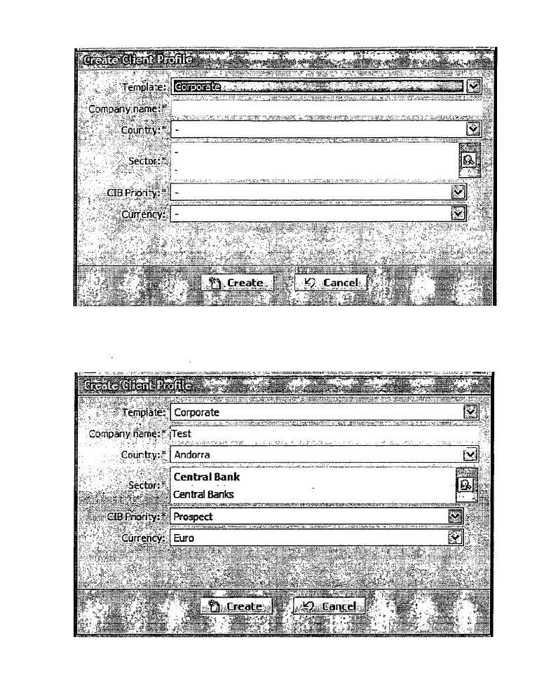

FIG. 5 provides an example of “tree” of General Data Screens and Product Screens, and some corresponding Sub-product Screens, as well as Sub-sub-product Screens.

FIG. 5B shows the “Client Profile Advanced Search” which allows Users to search for one or a combination of criteria chosen among (i) the list of Countries and blocks of Countries; (ii) the list of Sectors and Sub-sectors; (iii) Users meeting certain criteria; and (iv) any data parameter in a Client Profile.

The “Client Profile Advanced Search” offers Users a powerful search engine. It significantly enhances the search capabilities offered by the Client Profile Simple Search that only allows Users to search for Clients using a combination of characters appearing in the Client name. The Client Profile Advanced Search can be accessed from the Menus, a Client Profile or the Simple Search.

The Client Profile Advanced Search Screen can be used to build one's own query and to configure how the Advanced Search results will be displayed. A Criteria builder is used to select the Advanced Search criteria by combining any of the following main criteria and indicating which logical operations (AND, OR) should be applied between different parts of the Advanced Search. The Clients can be searched for using the following main criteria:
(i) By Client Profile Field Value—to search using any set of specified data values of any Client data fields; and/or,
(ii) By Country or Block(-s) of Countries where Client(-s) are located; and/or,
(iii) By Sector/Sub-sector(-s) where Client(-s) operate; and/or,
(iv) By User who covers a Client(-s).

### Creating A Client Profile, Including Product Profiles

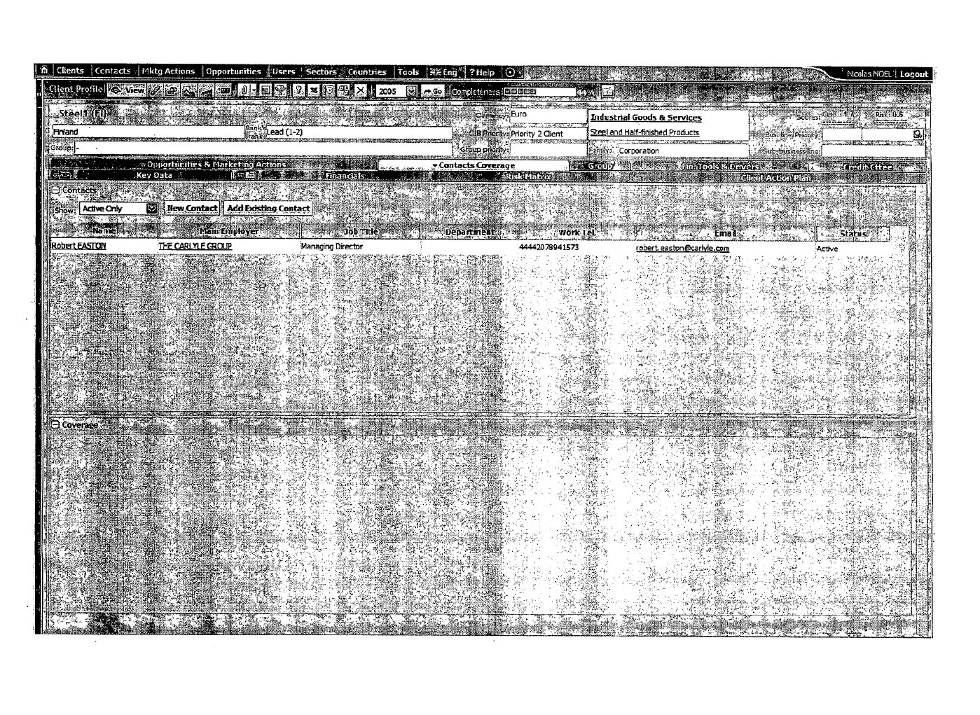

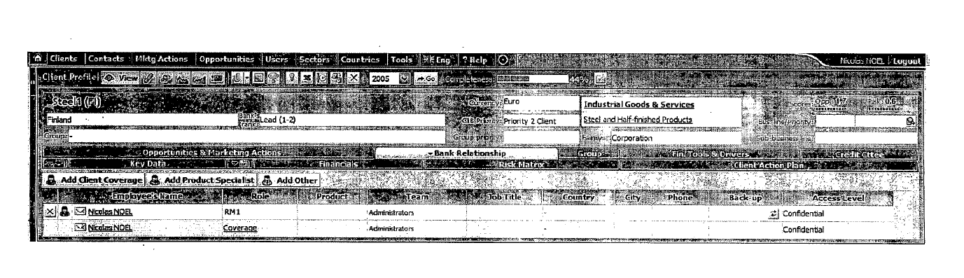

We now describe the creation of a Client Profile.
1) A User gives command to create new Client Profile. The System displays a “Create Client Profile Template” Screen as shown in FIG. 6. This Screen allows the User to select a particular Client Profile Template from a list of existing Client Profile Templates that the User would like to use to create the new Client Profile (E.g. Corporate or Financial Institution). This allows the User to easily find the most appropriate Client Profile Template to use.
2) An administrator can create a new Client Profile Template by selecting an existing Client Profile Template, and thereafter adjusting it as deemed necessary. An Administrator may create several “Client Profile Families”. For example, a “Corporate Clients Family” may be divided in a series of tailor-made Client Profile Templates, one for each of the following categories: Standard Corporates, Airlines, Leasing companies, Shipping companies, etc. Likewise, a “Financial Institutions Family” may be divided in a series of tailor-made Client Profile Templates Central Banks, Insurance Companies, Hedge Funds, Commercial Banks, etc. This structure in “trees” allows an extensive scalability in terms of creating Families of Client Profiles and allows each Client Profile to be highly relevant to its chosen sector of activity, while at the same time keeping strong similarities with other Client Profiles in the same Family. The business logic implemented by the System combines (i) highly fine-tuned Client Profiles, but (ii) gathered by Client Profile Families, (iii) with a maximized degree of similarity in terms of lay out and many shared Data Parameters, to maximize search ability of the Data and consistency throughout the System.
3) The User selects a Client Profile Template and then types in a company name, selects from a drop-down list a specific Country, then selects from a list of Sectors and Sub-sectors the relevant Sub-sector, then selects from a drop-down list the level of marketing priority for the said client, and eventually selects from a drop-down list the relevant currency in which the Client Profile shall be created, then clicks “Create”. Otherwise the User clicks “Cancel”, then the System reverts to the System Menu Screen.
4) The System then displays the “General Data” screen of FIG. 2 (in other, embodiment of the System, the by-default screen is the Opportunities & Marketing Actions screen). This screen allows editing (once the edit icon is clicked on) of “Client Index Data” (Company Name and Country), as well as the rest of the header: Group to which said Client belong—if applicable, Sector, Sub-sector, Family (E.g. Corporate), Currency, Bank's rank (among this Client's bank relationship) Group Priority in marketing terms for the Bank, and Marketing Priority levels for the main business line. The Total Opportunity Score and Total Risk Score (each as defined below) are “calculated” Data derived by the System, not inputted by any particular User. The scores are recalculated each time a saves a User screen. They can be calculated on the basis of temporary data input by the correct user and/or other users, or on the basis of validated data stored in the System.
5) After the User has clicked “Create” (the new Client Profile), the System verifies whether a similar Client Profile already exists in the System. If it exists, the System displays the following notification message: “A Client Profile with the same legal name (Company Name) already exists in the same country (Country). Please clarify, if possible. By default, a number will be added at the end of the legal name. E.g.: Exxon2, if Exxon is already included in Database in same country”. If the User clicks OK, then the System adds a number (following the existing one in the Database) at the end of the Company Name value and reverts to the “General Data” screen.
6) The System displays the following notification message: “Unless you have specified the Data Status (Public, Semi-confidential, Privileged (for listed companies) and Sensitive (for unlisted companies), each as defined below) for each Data Field, it will be the one specified by default (the “Default Data Status”). Continue?”
7) To continue saving the Client Profile, the User clicks “Create”. Otherwise the User clicks “Cancel”.
8) The Authorized Coverage Person (Client Profile Owner) can edit the Default Data Status within a particular Screen of Client/Product Profile correspondingly and only within it. These changes do not affect other Client/Product/Sub-product Profiles, but applies to this particular Screen within a particular Client Profile. It allows the User to view current Data Status (default or last edited) of each Data Field as well as to edit it. By default any Data Field is “Public” (i.e. any User can see and modify it) unless its status has been changed by the Authorized Coverage Person (Client Profile Owner). There are 3 types of Data Status to be supported:
(i) “Public Data” refer to the Data available to all Users, because the Data have been obtained from a public source, this is by-default the Data Status for most of the Data Parameters;
(ii) “Semi-Confidential Data” refer to the Data which are difficult to obtain and may have particular commercial value for the financial institution. As such, the Semi-Confidential Data will only be made accessible to Users with a sufficient seniority within the institution, and as defined in their User Profile (see Section “Manage User Profile”); and
(iii) “Confidential Data” refer to Data which are not at all publicly available and generally for which there is a requirement (either explicit or implicit from the Client's part) to protect this information, as a result, the Confidential Data will be made available only to specific Users. The system allows to split this Confidential level into “Privileged Data” and “Sensitive Data”, in order to distinguish respectively between listed and unlisted companies.
   User selects the Current mode to “Edit Confidentiality Mode” for a particular Client Profile Screen. In terms of work flow, the System displays screen in “Edit Confidentiality Mode”. A Screen in this mode has the same structure as the corresponding Screen in the View mode. At the same time, this mode allows a User to view the current Data Status assigned to the Data Parameters (default Data Status or last edited Data Status). Different Data Status are represented by different colors (Confidential=light red, Semi-Confidential=light orange, Public=no color, white background). This mode allows a User only to view and edit the Data Status. A User edits the Data Status by mouse left button click on the Data Field. For example, one left click on a Data Field with that has its status Public (white) changes the Field status to Semi-Confidential (light orange), and one more click changes the status from Semi-Confidential to Confidential (light red), etc. A User clicks the “Save” button to save the changes in the Fields Data Status in the Database. If the User would like to cancel editing of Data Status see Alternative Flow “Cancel Editing Data Status”. System saves changes in Database and displays the corresponding Screen in the View mode.
9) System saves the Client Profile in the Database and displays the “Client Profile Screen” in View mode (where all Data Fields are disabled for editing).
   The System invokes a Product by User combination of Data Parameter Values from the Country Profile that match the Country of this Client Profile. Then the System creates new lines on the Coverage Screen within the Client Profile with Product—User combination of Data Parameter Values.
11) System saves the User as Authorized Coverage Person associated with this particular Client Profile.
12) System updates User Profile associated with the particular User who created this Client Profile with Client information in the following way: the System adds Company Name, Sector, Sub-sector and Country values into the list of Centers of Interest within User's User Profile and marks them with “Inferred” status.
13) Preferably, the System logs corresponding Data into Change Log: (i) all Data modifications into the History Log; and (ii) User actions into the Audit Log.

Products and corresponding Sub products are part of a Client Profile. These are proposed by Products Specialists as being appropriate for certain categories of Clients and are then, if accepted by a Client Profile Template Administrator, attached to the relevant Client Profile template. The Product Screens together with Sub-product screens and sub-sub-product screens together form a product profile. For example, corporate securitization is divided into several sub products, one of which is the securitization of trade receivables, and each sub product is itself divided into several sub products.

### Editing a Client Profile, Including Product Profiles

### Access Rights to Public, Semi-Confidential and Confidential Data

For a given Client Profile, the edit rights are attributed to Users as follows: (i) any User can edit Public Data; (ii) only Users having been granted Access Rights to the Semi-confidential Data of the given Client Profile can edit Semi-confidential Data of this Client Profile; and (iii) only Users having been granted Access Rights to the Confidential Data (I.e. Privileged or Sensitive) of the given Client Profile can edit the Confidential Data of this Client Profile. Access Rights to Semi-confidential Data and to Confidential Data are granted based on the section “Manage User Profile” below (section “Access Rights”) and “Grant Access to Confidential Data” below.

If the User has been granted access to Confidential Data in a given Client Profile, then he is automatically granted access to the Semi-confidential Data in this Client Profile. If the User editing the Client Profile is not the Authorized Coverage Person (also called the “Client Profile Owner”), any Data editing he performs should be treated as Temporary Data. It means that these Data can be removed an unlimited number of times up to the last saved Validated Data for this given Data Field. When Temporary Data is validated by an Authorized Coverage Person, it becomes Validated Data. Thereafter, the Validated Data cannot be reversed and accordingly the various versions of the Temporary Data (until the last then Validated Data) which had been saved are erased. The System however indefinitely saves the most important previous versions of the Validated Data. When the User performing the editing is the Authorized Coverage Person, then the edited Data directly are “Validated Data”.

### Actors (Roles)

1) An “Authorized Coverage Person” (the User who created this particular Client Profile)—has full Access Rights for editing this Client Profile. This includes Confidential Data, Semi-confidential Data, Public Data, as well as the “Client Index” (Company Name and Country) and the rest of the General Data (Sector, Sub-sector, Client's Unique Reference Number, etc).
2) A “Coverage Person” (the User to whom Authorized Coverage Person delegated some Access Rights)—has Access Rights delegated to him/her by the Authorized Coverage Person, except changing the Client Index (Company Name and Country).
3) The “Overall Administrator” has all Access Rights in the Database.

The Data Values are edited and saved in the Database as “Temporary Data”. As an alternative the Data Values are directly saved as “Validated Data” when the User is the Authorized Coverage Person or the Coverage Person.

### Basic Flow

1) As a pre-condition, a User is logged into the System. The User gives a command “Switch to Edit mode” to edit a Client Profile from any Tab of the Client Profile. The System checks if the User is authorized as Authorized Coverage Person. If yes, then the User has the additional functionality of being able to edit the Client Index.
2) If User is not authorized as the Authorized Coverage Person, then the System checks if the User has access to Confidential and/or Semi-confidential Data based on his Access Rights. If access is granted this User is allowed to edit this Confidential and/or Semi-confidential Data, otherwise he is not.
3) The System displays a corresponding screen of the Client Profile (the Tab from which the User gave the command) in the Edit mode. This screen allows the User to edit Data Fields within the particular Tab of the Client Profile. For editing “Coverage Screen” within Client Profile see below. A Data Field marked with “Confidential” or “Semi-confidential” Data Status will be displayed with “No access” value for the Users who don't have access to it.
4) The User edits any Data Fields (fills in the new Data Values or overrides existing ones) within this particular Tab of the Client Profile.
5) The User clicks “Save” button to save changes in the Database.
6) The System validates the Client Index.
7) The System verifies if the Client Profile already exists in the System.
8) The System validates the Data Format of each Data Field.
9) The System saves changes to the Client Profile in the Database as “Temporary Data” and displays the Client Profile in View mode (where all Data Fields are disabled for editing).
10) The System logs corresponding Data into a Change Log: (i) The System preferably logs most Data in the Database; and (ii) the System logs User actions (UserID, ClientID, Date).

### Rules for Editing a Coverage Screen

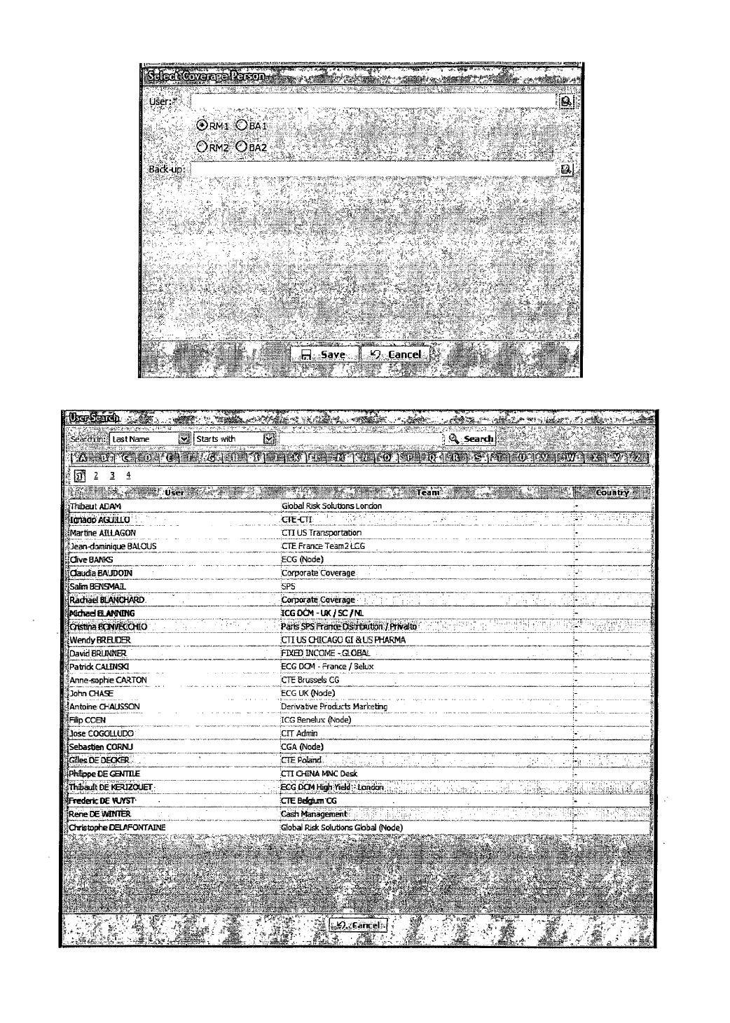

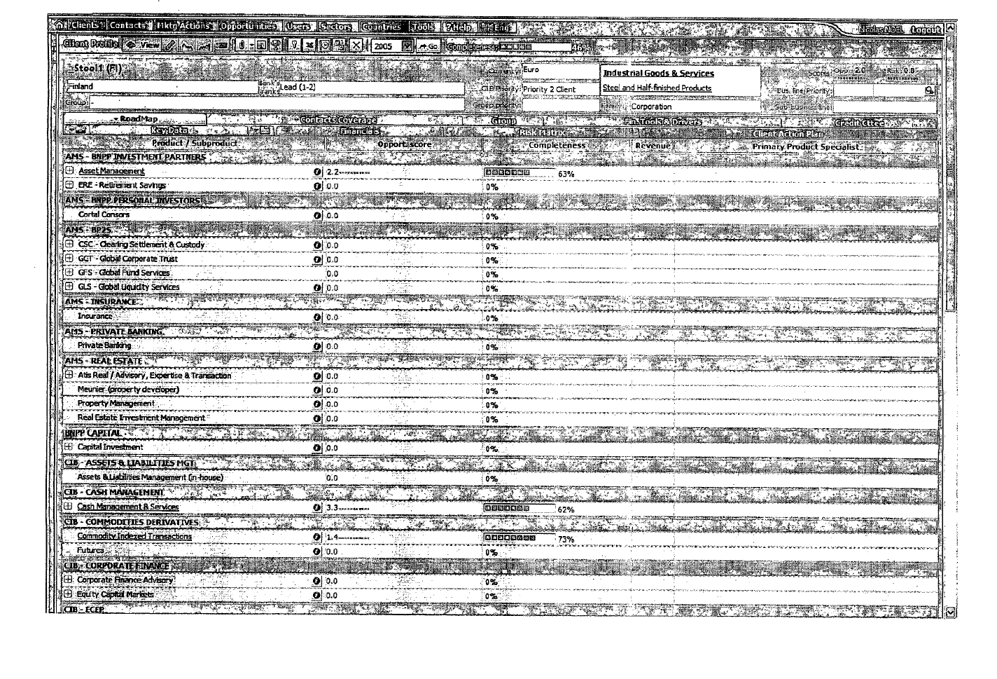

As shown in FIG. 7, the Client Profile includes a “Contacts Coverage” screen and a “Bank Relationship Coverage” screen: (i) the first screen includes the Contacts within a given Client, as well as the Coverage—or bank employees, such as Coverage Persons and Product Specialists who cover those Contacts; and (ii) the second screen includes the Client Coverage (also called Coverage Persons), the Product Specialists, and the other Users (working for instance in the Risk, IT or Legal departments).

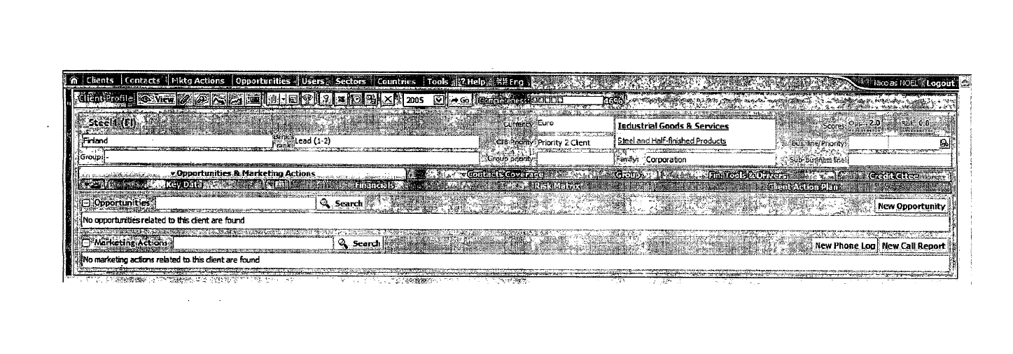

In a future version of the System, by default, the Product—User association, in other words the User assigned to the Product for the particular Client located in the particular Country is the Primary Contact Person in charge of Client—Country—Product association, as it appears in the relevant Country Profile. The said User (generally a Product Specialist) can however replace himself/herself by another User (a “Replaced User”) only for Products for which the User is assigned by the following steps.
1) The User clicks “Replace User” button for the appropriate line.
2) The System displays a pop-up window—see FIG. 8. It allows the User to search and select the Replaced User.
3) The User searches for the Replaced User and selects the appropriate one. The User clicks the “Replace” button to save the assignment of the Replaced User. If the User clicks “Cancel” the System reverts to the initial “Coverage” screen.
4) The System saves the changes.
5) The System deletes the corresponding line of “Client—Country—Product' combination of Data Parameters from the User's Matrix of Competence. System adds the line of “Client—Country—Product” combination of data parameters into the Replaced User's Matrix of Competence.

### Viewing a Client Profile, Including Product Profiles

### Definition and Business Rules

This allows any User (a General User) to view a Client Profile. The System displays a Client Profile Screen in a View Mode as read-only (not editable). A Client Profile Screen (refer FIG. 2) contains the following Data:
“Client Index” that includes Company Name and Country, Group (to which—if any—belongs the Client), Client and Group's level of marketing priority within the Financial Institution (for the entire CIB or Corporate & Investment Banking activity, as well as for key Business lines), Client's Sector and Sub-sector, Currency, and Bank's competitive position (among this Client's banks).
“Completeness” (in percent) that is the same as Total Criticality Mark. Completeness is represented by the same value for all General Data Screens and individually per each Product Screen. For a full definition, see below.
General Data Screens contain both a total Opportunity Score (in percent) and a total Risk Score (in percent). Product Screens contain only an Opportunity Score computed individually for the given Product. For full definition, see below.
A tab entitled “Opportunities & Marketing Actions” provides access to the following sub-tabs: (i) Opportunities & Marketing Actions, (ii) “Roadmap”, which contains first the list of Product, Sub-products, Sub-sub-products etc, with for each of them (ii.1) the relevant Opportunity Score and Completeness Score, showing the extent of the deemed opportunity for the said product, and the extent of the information filled in within the corresponding product screen, (ii.2) the revenues made by the Bank on said Product with that Client; and (ii.3) the Primary Product Specialist for the said Product; (iii) the “Bank's Position”, which details the competitive position for a range of key Products that the bank holds within this Client's banking relationships; and (iv) the “Bank's profitability” in relation with this Client, detailed by Product and then by Sub-product.
Some General Dimension Screens which are directly accessible—without having to go via a switch box. Those can for instance be: (i) the Key Data, (ii) the Client's Financial statements, (iii) the Matrix of Risks affecting this Client, and (iv) a matrix showing the Financial Tools used by that Client, and the client's key driving factors. Also directly accessible to users are the Client Action Plan (described below), and the Credit Committee (which summarizes the key information in relation with the credit lines approved for the said Client).
Some further General Dimension Screens are accessible via a switch box push button, and these screens can comprise the following: (i) Activities, (ii) Client's Investment Patterns, (iii) Debt Matrix; (iv) Equity; (v) Equity Portfolio; (vi) Funding Structure; (vii) Mergers & Acquisitions; (viii) Peers group formed of Clients in the Database which are similar to the given Client; (ix) Ratings & Funding Costs; and (x) Tax information.
A switch box push button provides users with access to Product Specific Screens, which are organized over several levels (Sub-product, Sub-sub-product, etc), and among others contain screens dedicated to: High Yield, US Private Placement, Forex, Externalization, Global Trade Services, LBO, Loans, Bonds, Hybrid Capital, etc. As mentioned earlier, a more comprehensive list of Product is given in FIG. 5.
“Edit Mode” Button—to switch to the editing mode (see Section “Edit Client Profile”. Note: Buttons “Permissions” and “Edit Confidentiality Mode” buttons are available for the Client Profile Owner (Authorized Coverall Person) only.

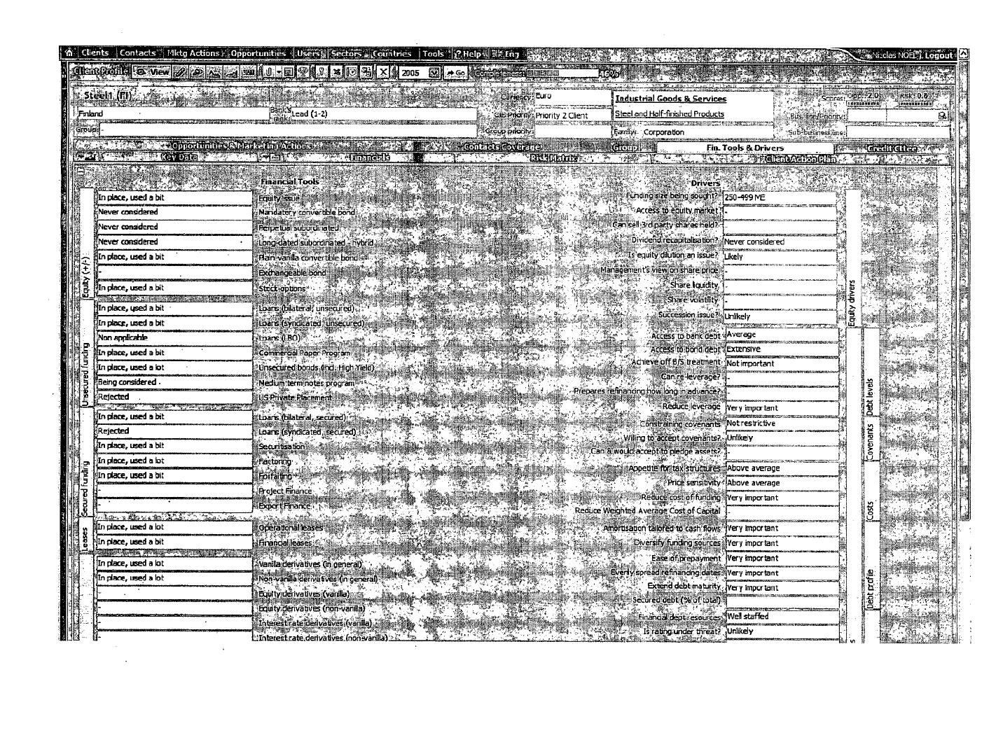

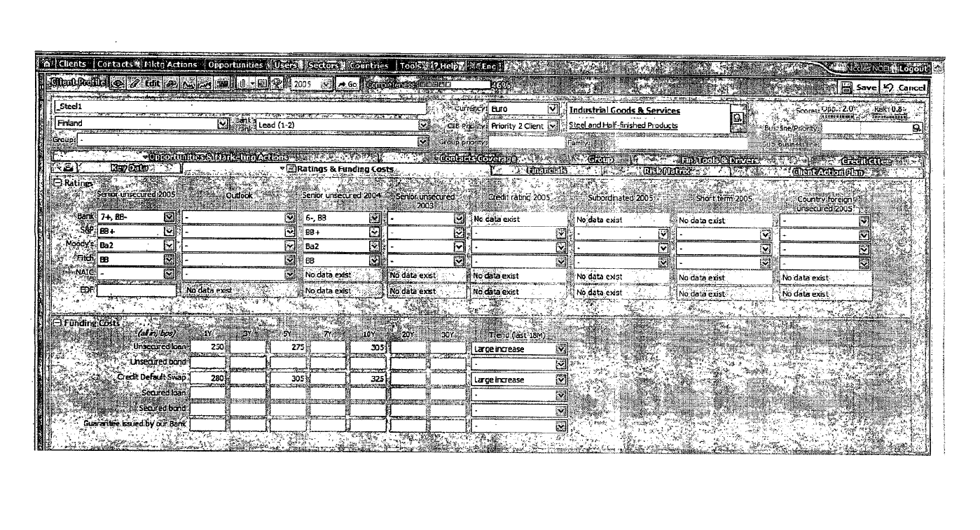

Some of the General Data Screens and the Product Specific Screens are shown in FIGS. 9.1 to 9.7.

The view rights in View mode are attributed to Users as follows:
Any User can view Public Data.
Only the Users who have been granted Access Rights to the Semi-confidential Data of the given Client Profile can view the Semi-confidential Data of this Client Profile.
Only the Users who have been granted Access Rights to the Confidential Data (Privileged—for listed companies—or Sensitive) of the given Client Profile can view the Confidential Data of this Client Profile.
A User who is authorized as Authorized Coverage Person (Client Profile Owner) for the particular Client Profile is automatically authorized to view all the Data within this Client Profile.
If the User has been granted access to Confidential Data, this User is automatically granted access to Semi-Confidential Data in the Client Profile.

### Basic Flow

1) A User gives a command to view a particular Client Profile (e.g. invokes a Client Profile from a Search Screen).
2) The System checks whether the User is the Authorized Coverage Person (Client Profile Owner) for the requested Client Profile. If yes, then the User has access to view all Data within the Client Profile.
3) The System invokes Use Case “Check. Access Based on Data” to verify if the User has access to Confidential and/or Semi-Confidential Data of the given Profile.
4) The System displays the relevant Client Profile (by default the “Key Data” Screen—see FIG. 2) in By-default View Mode (read-only, where all Data Fields are disabled for editing). Confidential and Semi-Confidential Data are not displayed to the User unless the User has the corresponding Access Rights.
5) The User clicks on any of the tabs to access any of the General or Product Screens.
6) The System displays a requested General or Product Screen with a corresponding value of Completeness (criticality), Opportunity Score and (if General Data Screen) Risk Score. These scores are computed when the screen is requested. They can be based on the last validated data, all temporary data that has been input or based on a subset of this temporary data.

### Scalability of Client Profile, Including Product Profiles

Each Product Screen belongs to a specific “Family of Products”. Each Product Screen can itself provide Users with access to one or several Sub-product Screen(-s), these being Screens focusing on a specific Sub product. Likewise, each Sub-product Screen can itself provide Users with access to one or several Sub-sub-product Screen(-s), these being Screens focusing on a specific Sub-sub-product. Etc. . . . . The Product, related Sub-products and related Sub-sub-products together form a Family of Products. Each Product Screen is created and managed by its specific “Product Screen Owner” (and likewise for each Sub-product and each Sub-sub-product).

Each Client Profile belongs to a “Family of Client Profiles”, these being defined as a group of Client Profiles using the same group of General Data Screens and Product Screens (each a “Client Profile Template”). Each Family of Client Profiles is created by the Overall Administrator, who designates a “Client Profile Template Owner” for each Family of Client Profiles. For illustrative purpose, each of the following categories of Clients can have their own Family of Client Profiles: (i) within the corporations, one can find—amongst others—the trading companies, shipping companies, airlines, real estate companies, leasing companies, service companies, manufacturing companies; and (ii) within the financial institutions, one can find—amongst others—the banks, insurance companies, hedge funds and central banks.

### Assign Score/Criticality Mark

### Definition and Business Rules

Only the relevant Client Profile Administrator (one per family of Client Profile Template) can modify the assignments of Score/Color/Criticality Mark to the Data Parameters in the General Data Screens. The Client Profile Administrator is designated by the Overall Administrator.

For each Product and each Sub-product Screen only the relevant Owner of the Screen (the Authorized Product Specialist) has Access Rights to modify assignments.

For one Client Profile Template there is only one Client Profile Administrator, one Product Owner per Product Screen (but one Product Owner can own several Product Screens), same for Sub-product Screen.

Different Client Profiles created based on the same Template will have the same Score/Criticality Mark assigned to the same Data Parameters. This allows on-going comparisons between various Client Profiles, and constitutes valuable input for the optimization of the Financial Institution's marketing and risk policies.

The “Criticality Mark” is assigned to each Data Parameter category, whereas Score and Color are assigned to the Data Parameter values within a category. Within a Client Profile Template, there is only one Criticality Mark per each Data Parameter. The Criticality Mark has the following values: “Nice to have”=1, “Useful”=2, “Important”=3, “Very important”=4, “Critical”=5.

Color depends on the Score for each particular Data Parameter value. There are 2 types of Scores: the “Risk Score” and the “Opportunity Score”. The Score values (both for the Risk Score and the Opportunity Score) are from −5 to +5. For General Data screens one Data Parameter can be associated with a Risk Score and/or an Opportunity Score, or no Score at all. For the Product-specific screens a Data Parameter will only correspond to an Opportunity Score (and not to a Risk Score).

The Score Value for a Data Parameter appearing several times in separate General Data screens should be the same (i.e. it should be taken into account only once in the Score calculation process).

If a modification of Score Value affects a Data Parameter appearing in several General Data Screens (e.g.; to increase the Criticality Mark from “Useful” to “Very important” for this Data Parameter), such modification is replicated throughout these Screens—and any inconsistency within these General Data Screens becomes structurally impossible (E.g.: where the Criticality Mark for the same Data Parameter was lower than “Very Important”, they are all now aligned on “Very important”, namely on the highest Criticality Mark assigned to this Data Parameter).

If a modification of Score Value affects a Data Parameter appearing in several Product-specific Screens, such modification is NOT replicated throughout the Product-specific Screens. This is because almost each Product Screen and Sub-product Screen is owned by a different Owner, and because each Product and Sub-product follows its own logic (e.g. in terms of Opportunity Score and Criticality Mark).

If a modification of Score Value affects a Data Parameter appearing in both one or several General Data Screen and one or several Product-specific Screen, then the modification is replicated throughout the General Data Screen, but not within the Product and/or Sub-product Screens.

The “Total Risk Score” is (i) the sum of all Risk Scores from all the Data Parameters within all General Data screens, divided by (ii) the number of Risk Score Values taken into account—throughout all General Data screens—in such Total Risk Score calculation process. There is only one Total Risk Score for all General Data screens.

Within a Product Screen, the Opportunity Score is calculated on a Screen by Screen basis (Product by Product, and Sub-product by Sub-product) as (i) the sum of all Opportunity Scores within the particular Product-Specific (or Sub-product) screen, divided by (ii) the number of Opportunity Score Values taken into account in such Opportunity Score calculation process.

As a result, the Total Risk Score and the Total Opportunity Score are each comprised in a range between −5 and +5 (as does each individual Risk Score and each individual Opportunity Score).

Within the General Data screens, the Total Opportunity Score is NOT calculated on a Screen by Screen basis, but across the entire set of General Data Screens. “Total Opportunity Score” is (i) the sum of all Opportunity Scores within all General Data screens, divided by (ii) the number of Opportunity Score Values taken into account—throughout all General Data screens—in such Total Opportunity Score calculation process.

If a Data Parameter appears several times in several General Data screens, the Total Score (either Risk or Opportunity) will take into account the relevant Score Value only once.

There is only one Opportunity Score per Product and per Product Screens. There is no Risk Score within the Product and Sub-product Screens (neither on a Screen by Screen basis, nor on an aggregate basis).

There are 2 Total Scores for General Data Screens: the Total Risk Score and the Total Opportunity Score. Each of them is calculated by (i) summing up the Score Values (each ranging from −5 to +5, attached to the various Data Parameters (taking each into account only once), and then dividing by (ii) the number of Score Values taken into account in this Score calculation process.

### Basic Flow

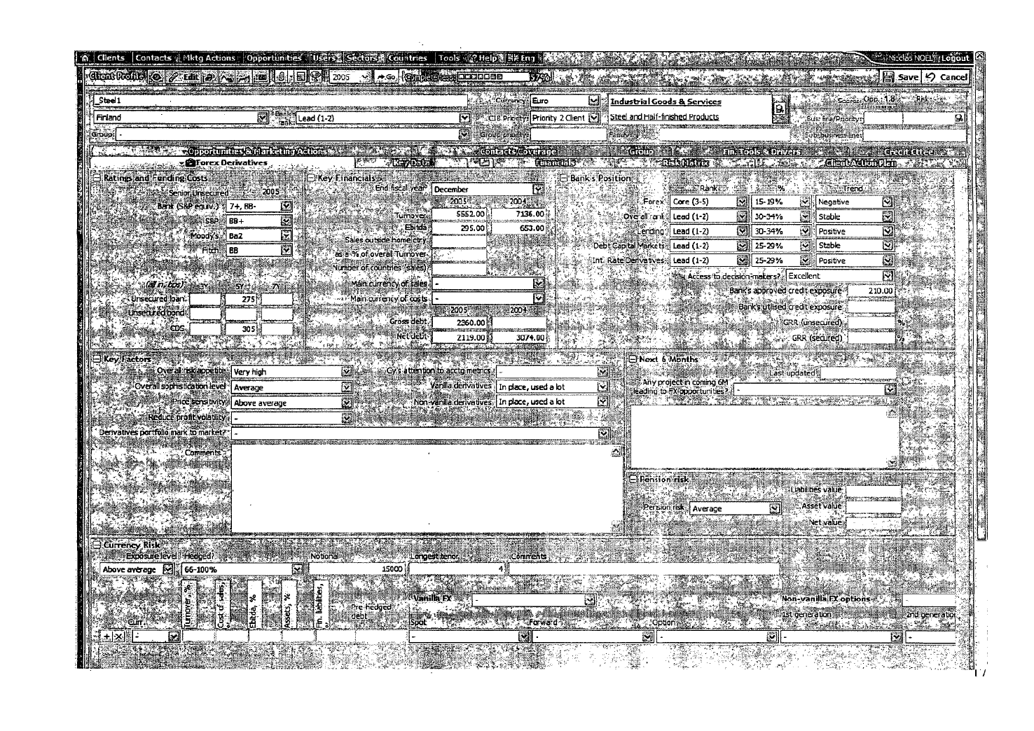

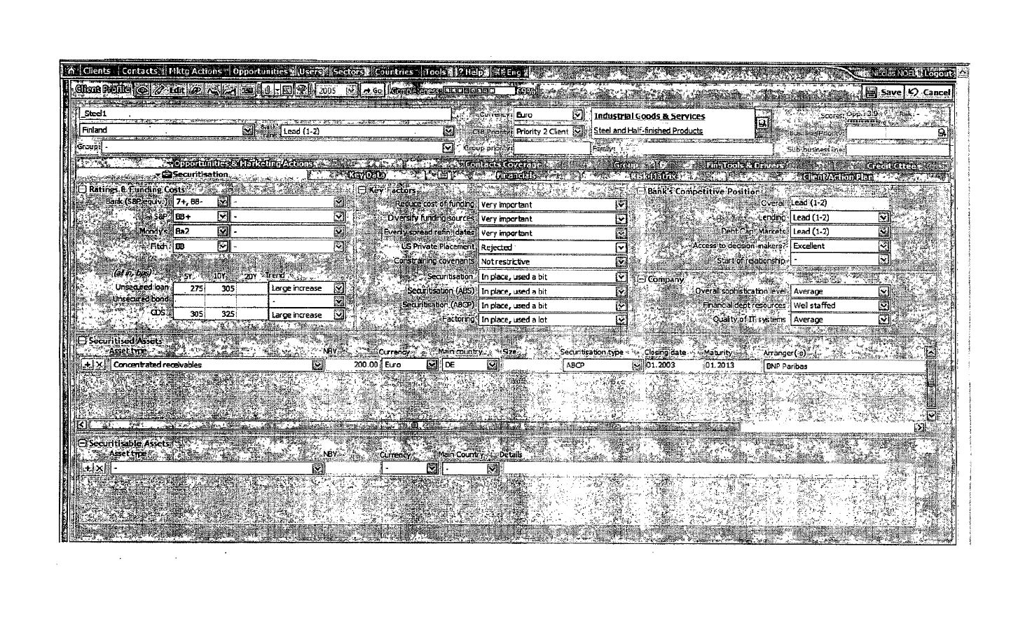

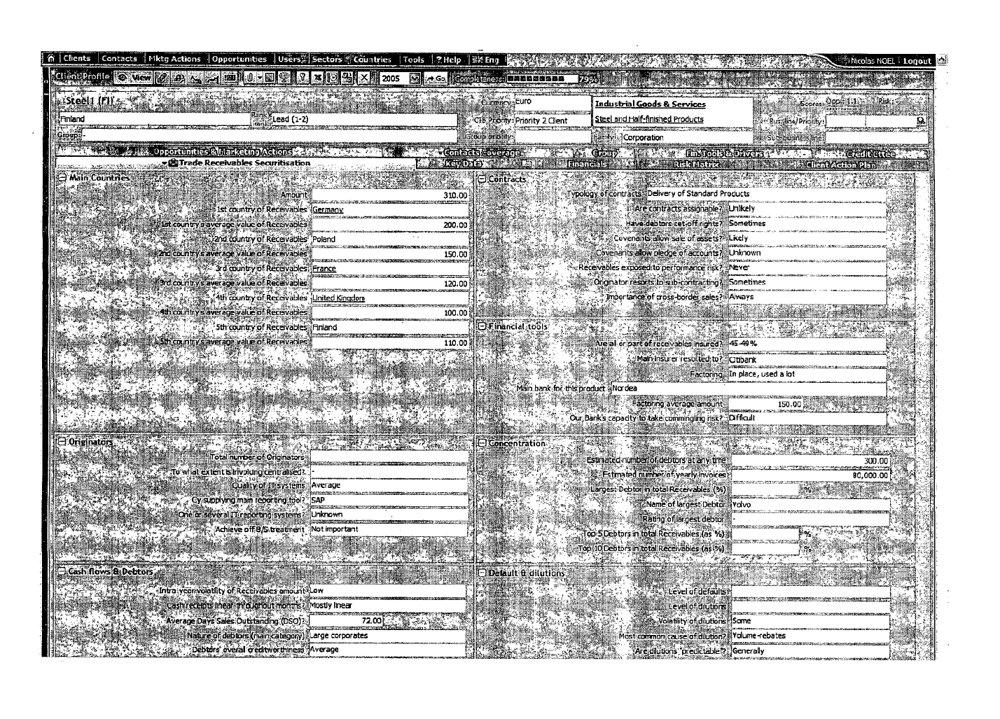

1) An Authorized User (hereafter referred to as a User) gives a command to modify Client Profile Template from any Tab of Client Profile.
2) The System displays Screen “Modify Client Profile Template” (see screen shot in FIG. 10). It includes a list of all Data Parameters within the Client Profile Template and allows the User to add, edit or delete assignments of Score/Color/Criticality Mark, for those Data Parameters.
3) The User selects the particular Data Parameter to add/edit assignments of Score/Color/Criticality Mark and gives a command to add/edit it. If the User wishes to delete an assignment then see section “Delete Assignment of Score/Color/Criticality Mark” below.
4) The System displays a Screen “Edit Score/Color/Criticality Mark” (see screen shot in FIG. 11).
5) The User edits the following Data:
   (i) “Criticality Mark” (it is applied to Data Parameter) which allows the User to select an appropriate Data Value (“Critical”, “Very important”, “Important”, “Useful”, “Nice-to-have”); and
   (ii) “Score” (it has values from −5 to +5) which allows the User to define the Type of Score (Risk or Opportunity), Data Value Range and Score, and Color for each of the Score value.

As indicated before, there are 2 types of Screens within the Client Profile:
(i) the General Data screens; and
(ii) the Product-specific screens.
For the General Data screens, one Data Parameter can be associated with a Risk Score and/or an Opportunity Score. For the Product-specific screens a Data Parameter will only correspond to an Opportunity Score (and not a Risk Score, though this functionality may be added later in further embodiment of the invention). The Score Value for a Data Parameter appearing several times in separate General Data screens should be the same, and should be taken into account only once by the system in the calculation of the Score.
6) The User clicks “Save” button to save changes in the Database.
7) The System validates the data format of each Data Field.
8) The System verifies if Data Value Ranges (in total) assigned to the Score Scale (from −5 to +5) cover all possible values of a Data Parameter or if Data Value Ranges overlap each other. If Data Value Ranges do not cover all possible values of a Data parameter or if Data Value Ranges overlap each other then the System displays a notification message “To be able to save data correctly all Data Value Ranges (in total) must cover all possible values of Data Parameter as well as different Data Value Ranges should not overlap each other.” The user clicks OK, and the System reverts to the last mode. The use case is continued with step 5 of the Basic Flow.
9) The System verifies if editing a Data Parameter associates it with different screens (it appears on more than one screen within the Client Profile Template). If editing Data Parameter appears in several General Data Screens, then such modification should be replicated throughout these Screens by the system. If editing Data Parameter appears in several Product-specific Screens, such modification is NOT replicated throughout the Product-specific Screens. If editing Data Parameter appears in both one or several General Data Screen and one or several Product-specific Screen, then the modification should be replicated throughout the General Data Screens, but not within the Product and/or Sub-product Screens. System replicates all the modifications of a Data Parameter throughout the General Data Screens where it appears.
10) The System saves changes to the Client Profile Template in the Database and displays a screen “Modify Client Profile Template”.
11) The System calculates a Total Risk Score for the aggregate of the General Data Screens within the Client Profile. Note: Total Score should be displayed for each particular Client Profile (see section “View Client Profile”).
12) The System calculates a Total Opportunity Score for the aggregate of the General Data Screens within the Client Profile (see section “Total Opportunity Score per General Data Screens”).
13) The System calculates a Total Opportunity Score per each Product and Sub-product within a Client Profile (see section “Total Opportunity Score per Product/per Sub-product”).
14) The System calculates a Total Criticality Mark for the aggregate of the General Data Screens for each particular Client Profile (see section “Total Criticality Mark per General Data Screens”).
15) The System calculates a Total Criticality Mark per each Product and Sub-product for each particular Client Profile (see section “Total Criticality Mark per Product/Sub-product”).
16) The System logs corresponding Data into a Change Log(see use case Track Changes of Data) below: (i) System logs all Data in the Database; and (ii) System logs User actions (UserID, Client ID, Date).

Total Scores Calculations
1) “Total Risk Score per General Data Screens” is calculated by (i) summing up the Risk Score Values (each ranging from −5 to +5), attached to the various Data Parameters (taking each into account only once) within all General Data screens; and (ii) dividing this sum by the number of Risk Score Values taken into account in the Score calculation process. As a result, the Total Risk Score also ranges between −5 and +5. There is only one Total Risk Score for all General Data screens. Within the General Data screens, the Total Risk Score is not calculated on a Screen by Screen basis, but across the entire set of General Data screens.
2) “Total Opportunity Score per General Data Screens” is calculated by (i) summing up the Opportunity Score Values (each ranging from −5 to +5), attached to the various Data Parameters (taking each into account only once) within all General Data screens; and (ii) dividing this sum by the number of Opportunity Score Values taken into account in the Scoring calculation process. As a result, the Total Opportunity Score also ranges between −5 and +5. There is only one Total Opportunity Score for all General Data screens. Within the General Data screens, the Total Opportunity Score is not calculated on a Screen by Screen basis, but across the entire set of General Data screens
3) “Total Opportunity Score per Product”: Within each Product (and Sub-product) Screen, the Opportunity Score is calculated on a Screen by Screen basis (Product by Product, and Sub-product by Sub-product) as (i) the sum of all Opportunity Scores: within the particular Product-Specific screen; (ii) divided by the number of Opportunity Score values taken into account in the Score calculation process in that specific screen. There is not a Total Opportunity Score across various Product screens. There is no Risk Score within the Product and Sub-product Screens (neither on a Screen by Screen basis, nor on an aggregate basis).
4) “Total Criticality Mark per General Data Screen” (also called the “Completeness Score”): The goal of Total. Criticality Mark is to allow Users to immediately know to what extent the Screens/Profile is or not “complete”, having taken into account that some Data are more critical than others. Total Criticality Mark per General Data Screens is calculated in the following way:

$$Total Criticality Mark per General Data Screens = \frac{\begin{matrix}Sum of Criticality Mark Values for filled in Data \\ Parameter within General Data Screens\end{matrix}}{\begin{matrix}Sum of all Criticality Mark Values within \\ all General Data Screens\end{matrix}}$$

5) “Total Criticality Mark per Product and per Sub product Screen”: Total Criticality Mark (also called Completeness) per Product (and per Sub-product) is calculated in the following way:

$$Total Critically Mark per Product = \frac{\begin{matrix}Sum of Criticality Mark Values for filled in Data \\ Parameter within one particular Product Screen\end{matrix}}{\begin{matrix}Sum of all Criticality Mark Values within \\ one particular Product Screen\end{matrix}}$$

An example of how the scoring operates in picture is now given.

A securitization of trade receivables is a funding arranged by a Bank for a Client (also called the Originator) whereby all or part of the client's receivables held on third party debtors are sold to a Special Purpose Vehicle (the “SPV”) which finances itself via the issue of Asset-Backed Securities and/or Asset-Backed Commercial Paper placed with capital market investors. The Client therefore receives upfront part of the future value of the “discounted” receivables. This is a financing mean which allows Clients to source funding secured by their receivables and therefore generally cheaper than unsecured funding instruments.

The “Trade Receivables Securitization” Screen provides Users with the information which are the most relevant to identifying an opportunity for the Bank to sell to this client a Securitization of Trade Receivables. For some of them (randomly selected for the purpose of this example, among the 50), the Data Parameter, the corresponding Drop-down list or Free Text) appearing in front of this Data Parameter, as well as the interaction with the Opportunity Score, as may be decided upon by the relevant Product Specialist who is the Owner of this Product Screen. An example could relate to a Client manufacturing dairy products (delivery of standard products, with no performance risk), under contracts which are likely to be assignable, such client having the right to sell assets (such as receivables), with some intra-year volatility, debtors of average creditworthiness with average concentration levels. The Client has access to expensive unsecured loans (75-100 bps above Libor). The Opportunity Score reaches 58% being 23 (the sum of the Opportunity Scores fetched for each Data Value) divided by 40 (the number of Data Parameters multiplied by 5, being the maximum which can be fetched on a scale ranging from −5 to +5).

The Risk Score works along the same principles.

The Risk and/or Opportunity Scores are re-calculated each time a User accesses (or saves while editing) the Screen; as a result, any modification affecting a Data Parameter forming part of the Scores is immediately reflected into these Scores.

Automatic matching between clients and products is carried out (i) within each Screen of each Client Profile, via the Opportunity Scores; and (ii) within the entire Application, through the Filter Scanning, which uses a Filter (being saved series of Advanced Search Criteria) and runs this Advanced Search through the Application to identify what Clients meet the specified Search Criteria in the said Filter. The results of the Filter are emailed to the Product Specialists and Coverage Persons respectively in charge of this Product and of each relevant Client, to outline which of the old or new clients meet or no longer meet the search criteria.

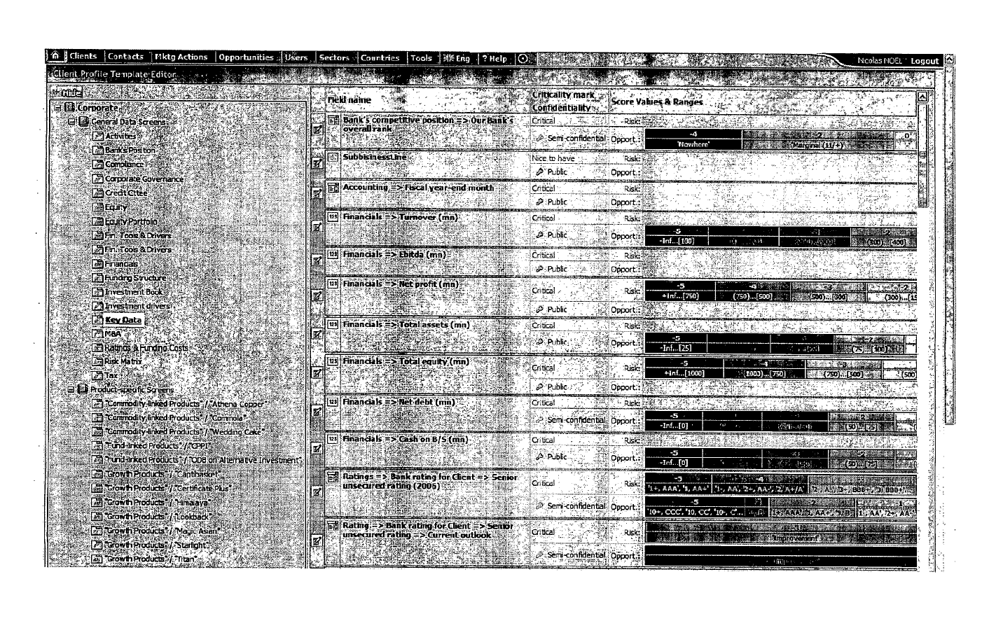

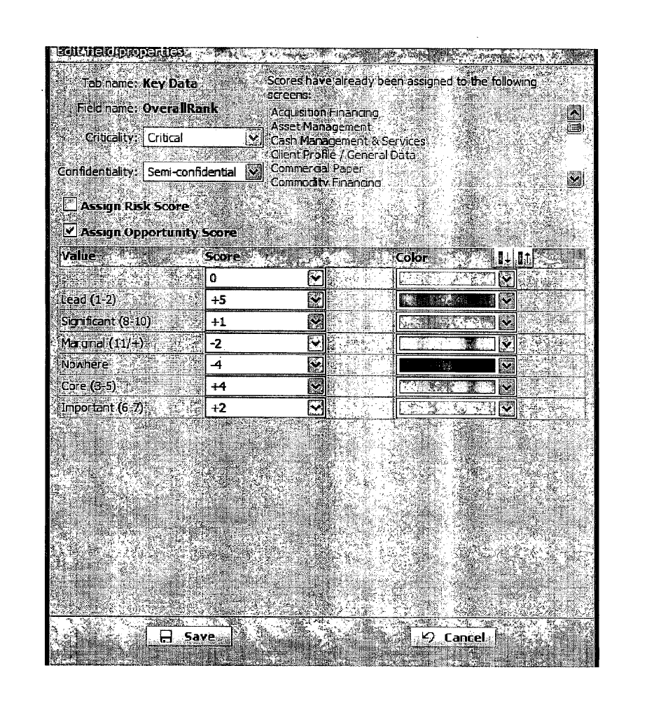

Opportunity Profile. Refer FIGS. 12.1 to 12.4.

Overview: The “Opportunity Profile” is a series of screens providing for a specific transaction (an “Opportunity”)—which (among many other examples) can be a syndicated loan, a corporate bond issue, an asset-backed securities issue, or a Merger & Acquisition transaction—all the necessary details organized in a series of Screens and under the same header. Such header contains the following information: Opportunity name and stage in the timeline, Product(-s) associated to this Opportunity, Privacy Level and (marketing) Priority, Client & Product Coverage (one person for each), reference Currency, Potential and Probabilized revenues, as well as Deal amount.

FIG. 12.1 shows the screen used to “Create an Opportunity”: (i) Heading describing the Opportunity; (ii) Client name; (iii) Privacy Level; (iv) Sale stage, and (v) Product(-s)/Sub-product(-s) related to this Opportunity.

In the Opportunity Profile, the first screen is called “Key Data” (refer FIG. 12.2). This screen contains (in addition to the above-described header) several sections: (i) a Timeline, namely the log book of all the Marketing Actions and Bank-internal approval, in relation with said Opportunity; (ii) the associated Product(-s), with some comments by Users; (iii) the Sponsors, namely other Clients—or non-Clients—being associated to this Opportunity; (iv) the Reward & Risk, namely the estimated closing date (or actual closing date, if Deal is already closed), the Deal length in years, the profitability associated to the said Opportunity, both during the first year and the next (with for the 1^{st} year a split between fees and margin), but also a set of qualitative assessment on the innovative and repeat characters of said Opportunity. The Opportunity profitability is analyzed using (i) “Potential Revenues”, corresponding to the maximum potential fees and other revenues during the entire life of the Deal; and (ii) the “Probabilized Revenues”, corresponding to the Potential Revenues multiplied by the “Probability of Success”.

Other screens contain: (i) the “Opportunity Team & Contacts”, with the Bank Employees and the Contacts, each interfaced with the relevant User and Contact Profiles (refer FIG. 12.3); (ii) the “Closed Deaf” which summarizes the Opportunity, with information such as the signing date, the deal name, associated Products/Clients/Countries/Sub-sectors, but also the Deal profitability, and the Users involved (and their role in the Deal) (refer FIG. 12.4); (iii) the “Drivers”, a screen which displays the reasons—also called drivers—behind an Opportunity, with each such drivers being interfaced with the Client Profile, and then frozen once the Deal is closed; and (iv) the “Tranches”—as may be applicable, which contains a description of the various tranches issued and to which investors they were sold. The System will allow to match (reconcile) Deal characteristics (E.g. in terms of currency, maturity, tranches, and rating, with investors' appetite as mapped in their own Client Profile).

Business purpose: The Opportunity Profile allows to track the lifecycle of an Opportunity in a seamlessly integrated manner with the rest of the InfoSystem: (i) fully interfaced—until the Deal closing (point in time when the data become frozen, a snapshot of the then existing data being taken)—with the Client Profile data; (ii) fully interfaced with the Contact & User Profiles; (iii) fully interfaced with the Opportunity-related Marketing Actions; (iv) with the Closed Deal screen being extensively re-used in a contextual manner in relation to other Client Profiles when those could be interested by correlated Products and/or are in same Country and/or Sub-sector. This last feature allows the Users to access a wealth of Opportunity Profiles with a view to understanding which Deals have already been closed in a specific Sector/Sub-sector and/or Country. It allows Users to have more innovative and/or quicker marketing ideas, and to publicize what the Bank is doing, both internally and externally.

Thus the Opportunity Profiles are extensively interfaced with the rest of the Application; namely (i) with the Client Profiles (i.e. the Deals closed with a specific Client), (ii) with the Sector & Sub-sector, and (iii) with the Country Profiles (i.e. the Deals closed in this Sector/Sub-sector/Country), and with the “2nd generation CRM” (see below). This provides a lot of synergies, in that the Bank's know-how on its own Deals or those closed by competitors can now reach the relevant Users based on their actual Centers of Interests (e.g. sectorial/geographical and/or product specific), as those Centers of Interest are declared by each User (in their own User Profile and in their Matrix of Responsibilities which lists the Clients, Groups, Sectors and Countries covered by said User) and inferred by the System from the traffic of that given User in the InfoSystem (E.g. what Screens have been recently viewed, or even more tellingly edited, by a given User).

The “Deal Pipeline” in relation with a specific Client is a series of Opportunities—at various stage of their marketing, arrangement or closing—as they appear in various Opportunity Profiles in relation to a specific Client. This screen can be accessed from the three menus, and is a more detailed version of the Opportunities Views showing for instance the User's Opportunities, or the User's Team Opportunities.

### Award, Benchmarks & Credentials Profile

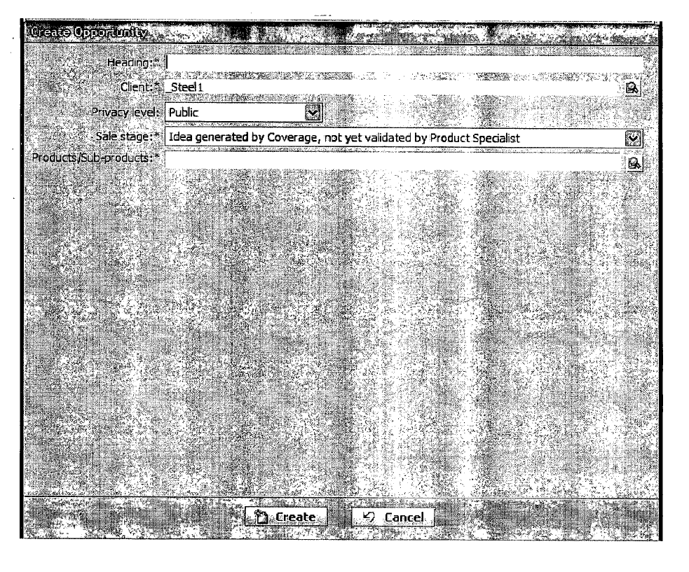

Overview: This screen automatically appears as a shadow page to each Product and Sub-product Profiles (each part of each Client Profile). It provides on a contextual basis the list of the Deals and Awards which bear a logical relation (in terms of relevance) with the said Product or Sub-product Profiles in a Client Profile. For example, the Deals and Awards outlined in the Benchmark & Credentials screen shadowing the US Private Placement screen of a Client active in the Brazilian steel industry, will have to relate to US Private Placement in the Steel industry, worldwide, and US Private Placement in Brazil. An example is shown in FIG. 13.

The “Award Section” focuses on any Award the Bank has received. In some cases, the Award relates to one or several Deal(-s) having their Opportunity Profile or not. In some other cases, the Award relates to the Bank's capabilities in general or specifically in relation to a Product or a Sub-product, and Country as the case may be. In all cases, the Award Profile is tagged (interfaced) with the relevant Opportunity Profile(-s), Product and/or Sub-product Profiles, and Country Profiles.

Business purpose: To increase Users' awareness of their Bank's capabilities and credentials, so as to allow them to better market their Bank and its Products, but also to broaden the scope of what Users believe is “feasible” and push them to innovate by thinking “outside of the box” (e.g. inventories of steel, or future steel exports, can be financed on a collateralized basis). We note that innovation is a leading driving force in many activity sectors, such as the financial sector.

Thus the Opportunity Profiles and Award Profiles are extensively intertwined (connected) with the various Profiles (Product, Sub-product, Sector, Sub-sector and Country) is innovative and significantly increases the Bank's capacity to foster new ideas, and to market itself efficiently.

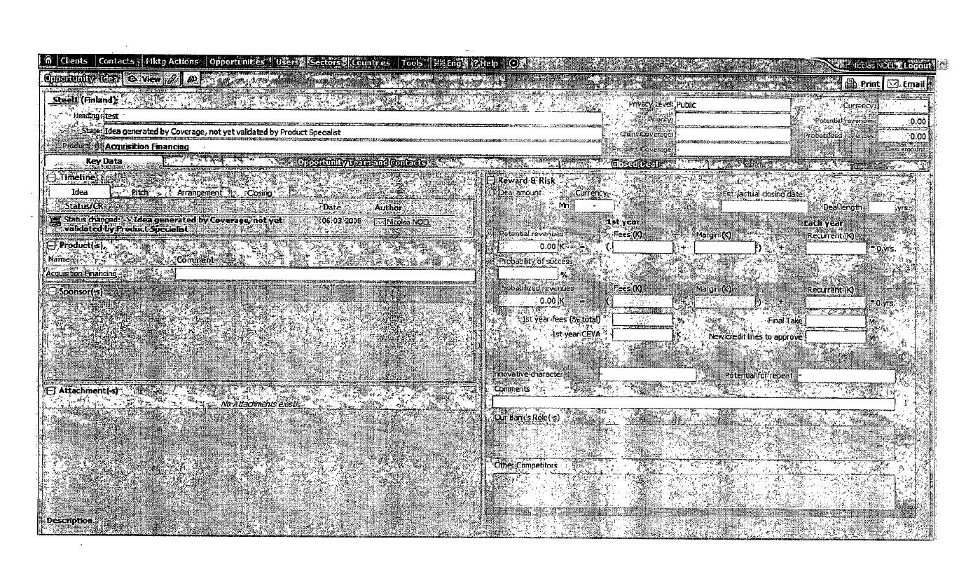

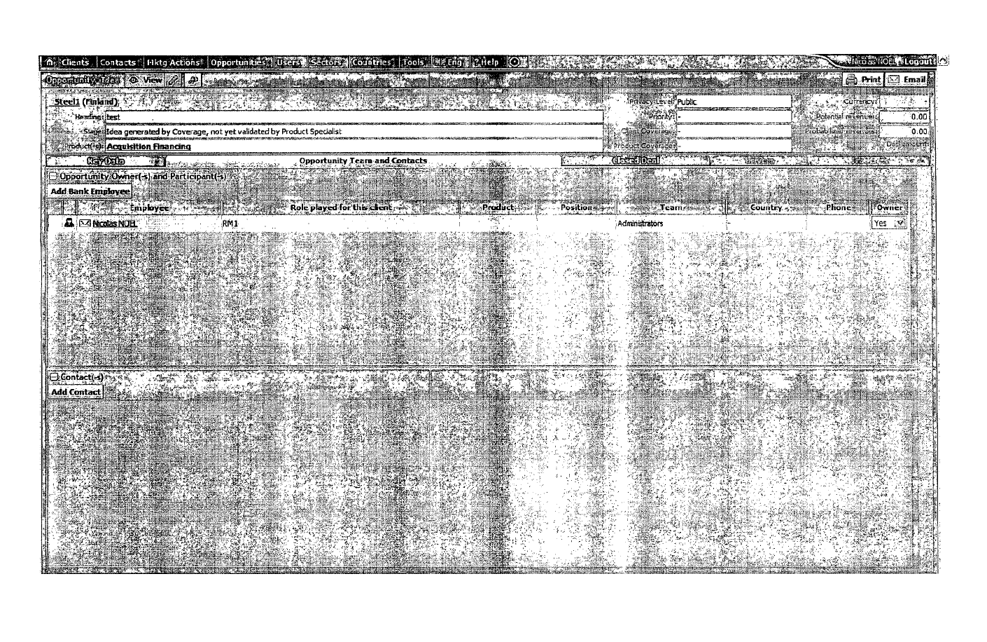

### Client Action Plan (Refer FIG. 14)

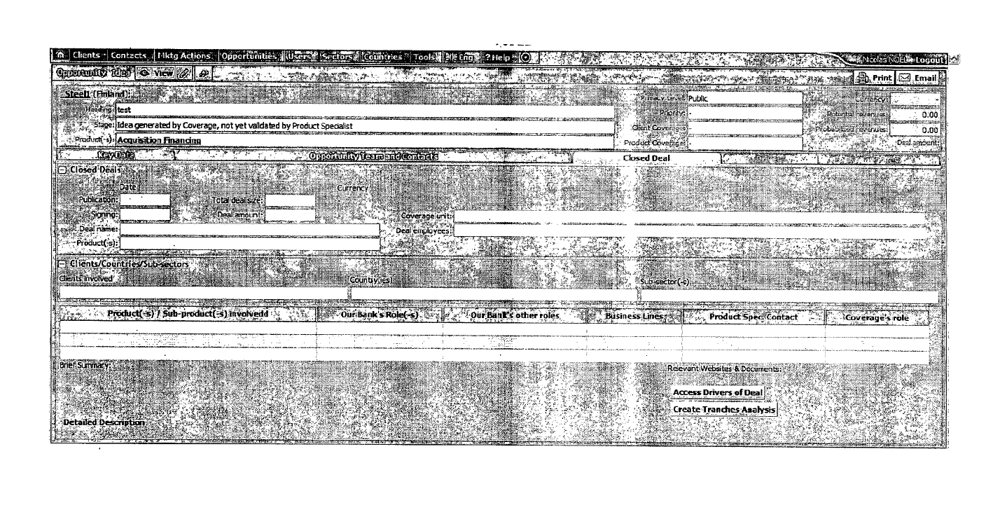

Overview: Each Client Profile is accompanied by a section which takes the appearance of a word document describing the Financial Institution's marketing action plan in relation with the said Client; hence the name “Client Action Plan” (or “CAP”). This section is extensively interrelated via hyperlinks with the rest of the Client Profile with also further connections to the Opportunity Profiles and Award Profiles, as well as with the Opportunity Pipeline and the Peer Group (each as defined here). The CAP is constituted of various chapters/sections presenting the Client's activity, equity structure, financials, as well as the Bank's marketing strategy and the Bank's competitors. The CAP ends up with exhibits, such as the “Peer Group” (refer FIG. 15)—which displays the Clients resembling the said Client to which relates the CAP—and the Opportunity Pipeline for the given Client, such pipeline being interfaced with the Opportunities View for the given Client.

Business purpose: The yearly review of the Financial Institution's marketing objectives with each significant Client is something which takes place in most financial institutions. Normally, the participants read a paper-based document of 4-8 pages summarizing the key information needed, and this document is produced ex nihilo.

Thus the Client Profiles are extensively interfaced with the CAP Document, so that when Users fill in some Data Parameters in the Client Profile (e.g. “Is the company acquisitive?” or “Core bank?”), these Data Values—if they are important in the CAP context—automatically appear in the electronic CAP document. This not only saves time, it also allows the CAP to be at least partially updated throughout the year, as opposed to be a document “frozen” each September, and not updated before the next September. The system also has the capacity to compare the Client's Product/Sub-product purchasing behaviour with that of its Peers, via the Peer Group table.

### Peer Group (Refer FIG. 15)

Overview: The Peer Group is a screen containing a table with the Clients which can be considered as “Peers” or competitors for the reference Client. The Peer Group is used both in the Client Profile itself and in the CAP which is interfaced with it. By clicking on each Client name, the User can access that Client's Client Profile/Sector profile/Sub-sector Profile/Country Profile.

Business purpose: From a marketing standpoint, the Peer Group allows Users to identify what type of Product/Sub-product a series of correlated Clients are buying. From a credit standpoint, the Peer Group also allows Users to compare the creditworthiness of each Client within this Peer Group. Please note that the Peer Group can also contain companies which do have a Client Profile even though they aren't active “Client” of the Bank.

Thus the Peer Group is interfaced with the rest of the Application, and therefore it is synergetically updated and can be exploited to spot trends in terms of appetence for a given Product, or in terms of creditworthiness, across a Peer Group.

### 2^{nd} Generation CRM

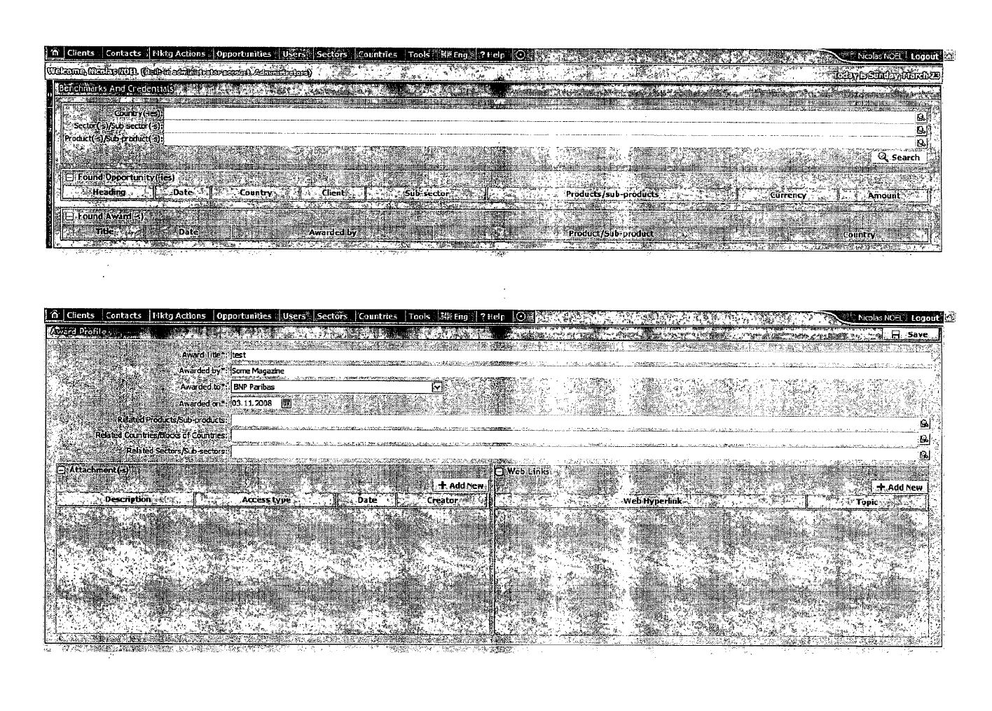

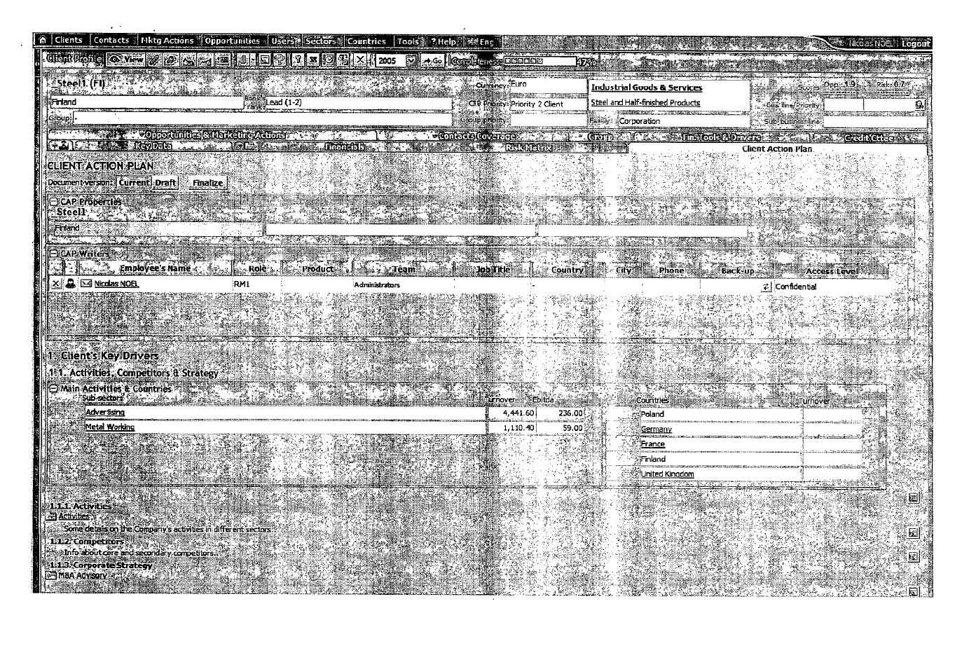

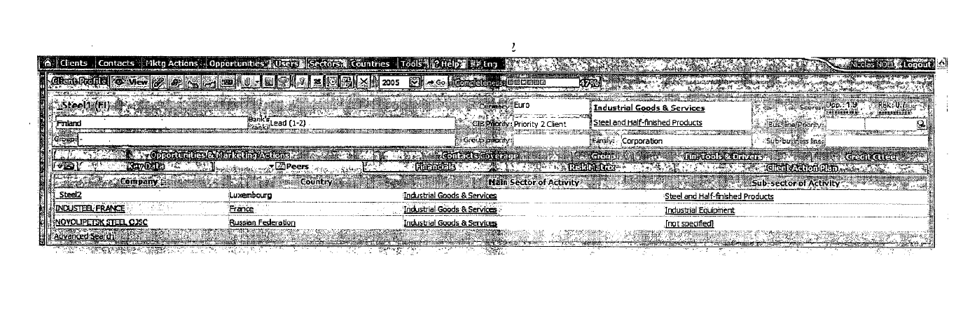

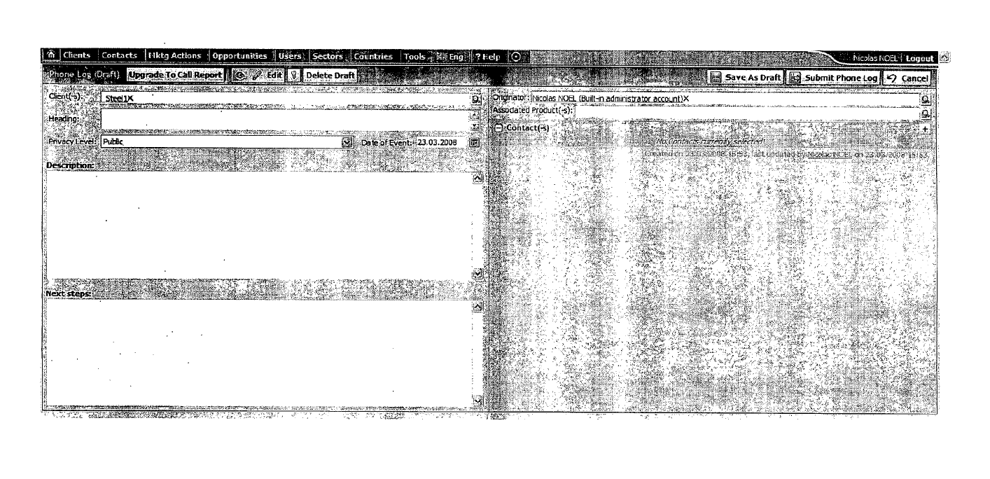

Overview: What we call “2nd Generation CRM” is a CRM which is extensively embedded into/interfaced (via hyperlinks) with a wider web of Profiles (Client, User/Contact, Country, and Sector) and Transversal Tools, as opposed to being mostly on a stand-alone basis (and occasionally interfaced with some accounting data feeders). For instance, the Call Report and the Phone Log(respectively the summary of a meeting and of a phone conversation, and each a Marketing Action) comprise information on the Opportunity(-ies), Client(-s), Product(-s) to which this Marketing Action relate, as well as the Contacts and Users involved. Wherever possible, the said entries are hyperlinked to their relevant Profile. FIGS. 16 and 17 respectively show a “Call Report” and a “Phone Log”.

Business purpose: By creating a lateral fluidity across the Application (via the hyperlinks) and by systematically benchmarking Client's behavior (via the Peer Group), the system accelerates the cross-selling and the diffusion of innovations across the Financial Institution's. Client base. Several Marketing Actions can be tagged together and linked to one or several Opportunity(-ies).

Innovation: By being extensively interfaced with the rest of the System, the 2^{nd} Generation CRM provides significantly more value added to its Users: (i) most of the words appearing into a deal pipeline are hyperlinked to Client/Country/Product/Sector/User Profiles and/or to the Application's Knowledge Database; and (ii) Users can compare what a given Client uses in terms of Products & Sub-products with what other Clients in the same Peer Group actually are using.

For a given Client Profile, the CRM information are not simply presented in one monolithic block (E.g. bundling various Products and Sub-products in one rigid Call Report), but are contextually fragmented in more directly actionable sub-components, (i) by virtue of being sub-divided into smaller Opportunities hyperlinked to an umbrella Head Opportunity Profile, and (ii) by virtue of being hyperlinked to various Client, Product, Sector, Country, User and Contact Profiles) so that for instance Hybrid Capital-related Marketing Actions will appear in a screen directly shadowing the Hybrid Capital Product Screen (and directly interfaced with it). Each Marketing Action therefore becomes very closely linked: (i) to the relevant Product or Sub-product Profiles, (ii) to the relevant Benchmark & Credentials Screen; and (iii) more broadly to each relevant Profile in the wider System. In a further embodiment of the System, each Call Report is comprised of a series of sections which can either be tagged by the Call Report Writer as “general” or be “Product/Sub-product specific”. The pyramidal structure of a Client Profile with its scalable layers of Products, Sub-products, Sub-sub-products etc, will be mirrored by the pyramidal structure of the Opportunity Profiles with their tagged satellite Opportunities (I.e. “Head Opportunity” and “Dependent Opportunities”).

Web 2.0 Collaborative Knowledge Database embedded into Application

Overview: The Web 2.0 Collaborative Knowledge Database allows Users to collaboratively and over time build together an extensive knowledge database covering most topics which they deem relevant to their organization's and department's activity (each an “Entry”). Such Entries are organized into “Families of Entries” (e.g.: Commodities or Legal), themselves split into “Sub-families of Entries” (e.g.: Crude Oil or New York Law). The “Key Entries” are Entries which (i) not only provide Users with a definition and with numerous hyperlinks to the rest of the Application, and—as the case may be—with some attachments and relevant web links; but also as well (ii) include an “Expert Forum” which provides the names of the Users who consider themselves as experts, available to be contacted by Users seeking some answers, each such Expert Forum and the related Key Entry being owned by a designated “Knowledge Expert” (who is one of the Users). (Examples of Knowledge Experts include Product & Sub-product Specialists, Country Specialists, Sector & Sub-sector Specialists.) Some Financial Institutions may accept that upon answering a question emailed by a User, each Knowledge Expert could be “remunerated” (as decided upon by the beneficiary User) and will receive “Points” with which such Expert will be able to acquire Not-for-free information from external sources.

The Points score will become an input in the Human Resources end-of-year performance review.

The Knowledge Database is a self-contained module in the Application. However, it is extensively interrelated (via hyperlinks) with the rest of the Application, including (but not limited to) the Client Profiles (including the Peer Group), the Product Profiles, the User Profiles, the Country/Sector/Sub-sector Profiles, and the 2^{nd} Generation CRM (Opportunity Profile, and Marketing Actions—namely Call Reports and Phone Logs).

Business purpose: The Knowledge Database answers a business need which is “to efficiently structure the information within large organizations”, such as Financial Institutions. It is said that Knowledge Workers today spend almost half of their working hours searching for information which is scattered across their Firm. Banks, for instance, generate a sheer volume of “Credit Applications”. (Note: these are typically Microsoft Word documents with Microsoft Excel attachments together describing the Client's strategy and creditworthiness, and used within the credit approval process.) A huge wealth of information is vastly under-exploited and difficult to access, and sits idle in the Credit Applications silos, but also sectorial or country analytical reviews. The Knowledge Database leverages the available information on any topic relevant to the organization: country & sector specific, product specific, legal & tax-related, accounting & financial topics, etc.

Innovation: By setting up a series of hyper-links in each of its Profiles (for instance between the word “Ebitda” as it appears in several screens of any Client Profile, and the Knowledge Database's entry containing a definition of the Ebitda, or between a credit review on a given Sub-sector and the various occurrences of the said Sub-sector in the various Profiles), the System ensures that a given piece of knowledge is extensively leveraged and accessible in a contextual (relevant) manner by any User, and what is more, at a time when he/she actually needs it.

### Contextual Advertisement

Overview: The System allows for targeted internal or external (free or paid-for) advertisements to be contextually shown to the User when he is viewing or editing a specific Screen. For instance, a Private Equity-related service provider will bid (against other advertisers) in order to acquire the right to the advertisement space on the Private Equity-related screens in a specific geographical area and/or sectorial perimeter (or for Clients meeting pre-set Advanced Search Criteria). Such Contextual Advertisement will appear on most (if not all) the Screens within the Application. This feature will be combined with the capacity to target specific sub-set of Users, based on criteria which could be geographic or reflect each User's Profile.

While the idea of having a Knowledge dictionary is not new in itself (for example www.wikipedia.org), what is innovative here is: (i) the extensive interrelation between the Knowledge Database and, in particular, the various Profiles (Client profiles, but also Sector/Country/User/Contact etc Profiles) and CRM components (such as the Opportunity Profile, and the Marketing Actions—Call report and Phone Logs), as this ensures a fluidity of information (across the Users' community); (ii) the possibility offered to Users to efficiently and contextually “leverage” the Knowledge Experts' knowledge, contacts, relationships and connections, throughout the organization, across silos (countries, departments, products, . . . ); and (iii) the “virtuous circles” created by (iii.a) remunerating Experts through information which the organization is happy to pay for, since it by definition knows that such Expert has a collaborative (team-player) behaviour and will therefore leverage the not-for-free information he/she will receive; and (iii.b) by allowing Contextual Advertisement.

### User Profiles

### Types of Users in the System

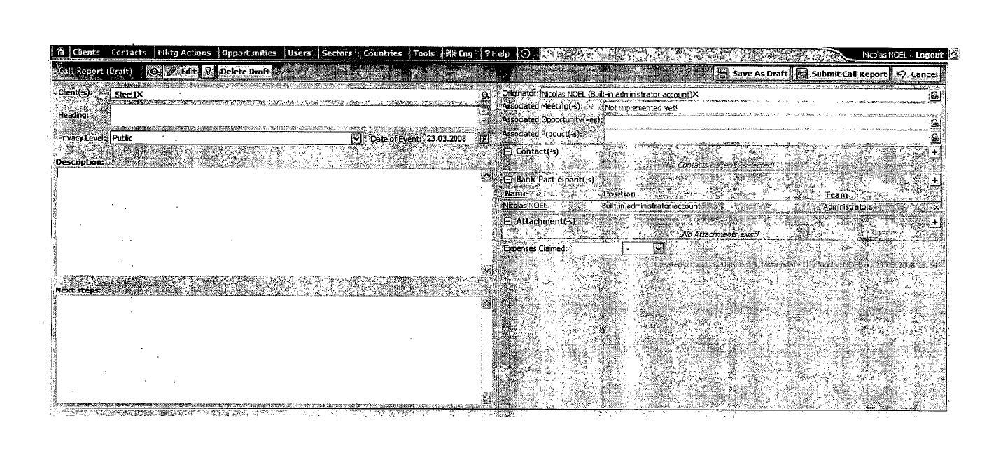

In this example there are 10 types of Users in the Application: (i) the Overall Administrator, (ii) the Administrator for a Family of Clients, (iii) the Line Manager, (iv) the Coverage Person, (v) the Product Specialist, (vi) the Client Owner, (vii) the Head of Territory (and his/her Substitute User), (viii) the Country Specialist(and his/her Substitute), (ix) the Head of Sector (and his Substitute, and the related Sector Specialists), and (x) a simple User (who does not belong to any of the previous categories). Please note that a User can occupy several positions at the same time: for instance, a User can be Product Specialist and Line Manager and Country Specialist. Each User can occupy several “Positions” and the System manages each Position independently. The InfoSystem will allow to reconcile the User's access rights to be able to define the User's combined access rights to data. FIG. 18 shows a screen shot for “User Profile Access Rights”.

A person who is not an employee of the Financial Institution is not a User, but a “Contact” (see below the Contact Profile).

1) The “Overall Administrator” has full authority in the Application: (i) to create, edit, amend and delete any type of Profile; and (ii) to create, amend or cancel any other User in the Application.
2) The “Administrator for a Family of Clients” is designated by the Overall Administrator and determines what Screens are included in the said Client Profile Family Template. He can amend the Client Profile Template, however while he can alone decide to amend the General Data Screen, he can't amend the Product (Sub-product) Screens without the Product (Sub-product) Owners' approval.
3) The “Line Manager” is a User to whom reports one or several Users. The Line Manager can himself/herself report to one or several Line Manager. The Line Manager validates the Matrix of Competencies, part of the User Profile of the Users who report to him/her.
4) The “Coverage Persons” who are in charge of the Organization's relationship with one or several Clients. Each Client Profile is owned by a Client Owner who generally is a Coverage Person, but can sometimes be a Product Specialist (see below).
5) The “Product Specialists” who are in charge of devising, refining, marketing and structuring one or several Products and/or Sub-products and/or Sub-sub-products. Each Product (and Sub-product/Sub-sub-product screen) is owned by a Product Specialist.
6) Each Client Profile is managed by the “Client Owner”, being a User—in most of the cases, a Coverage Person, but in some cases it could be a Product Specialist or any other User—who is in charge of the Organization's overall marketing policy vis-à-vis this Client. The Client Owner cannot alter the structure of the Client Profile (this is the Family Owner's remit), but is in charge of managing the confidentiality requirements by deciding what data Fields are not “Public” (the by-default choice), but are either “Semi-confidential” or “Confidential”.
7) The “Head of Territory” and “Substitute”, in charge of one or several countries and who owns/edits the Country Profile.
8) The “Country Specialist”, who belongs to the Economic Research Department and monitors one or several Countries from a risk stand-point.
9) The “Sector Specialist”, who belongs to the risk department and monitors one or several Sectors or Sub-sectors.

### Manage User Profile

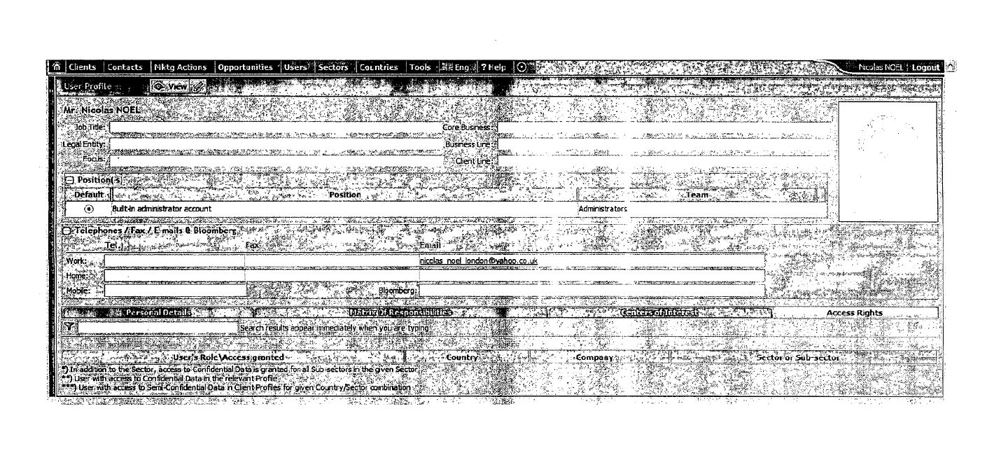

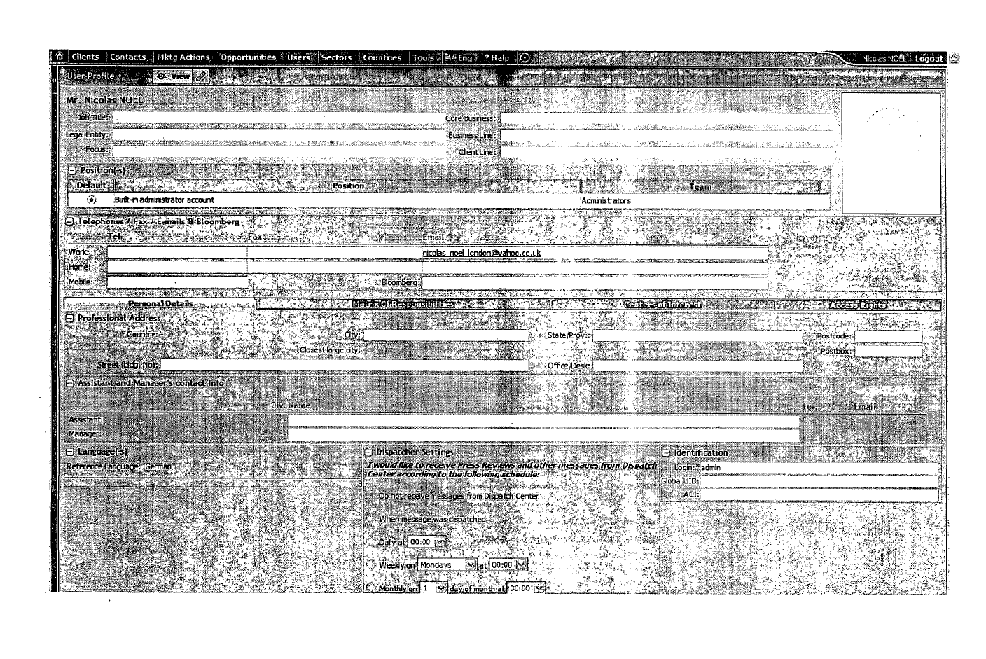

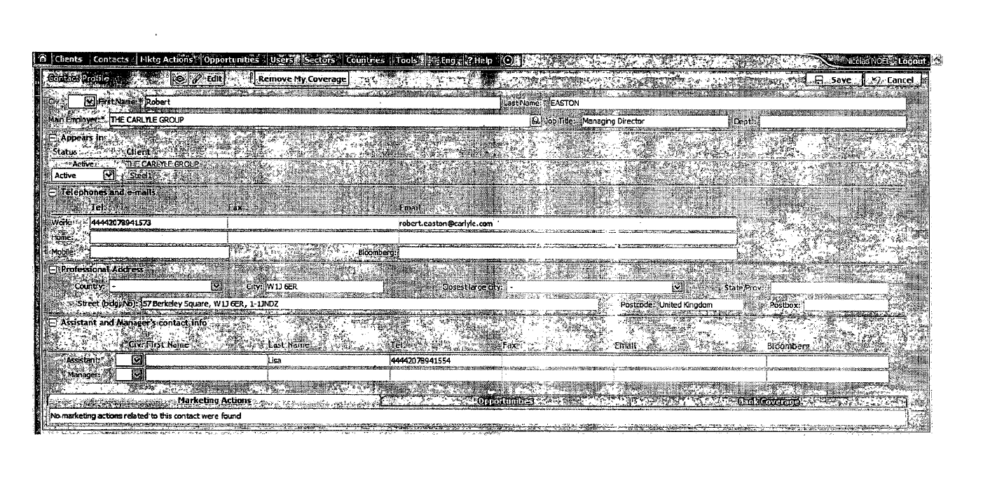

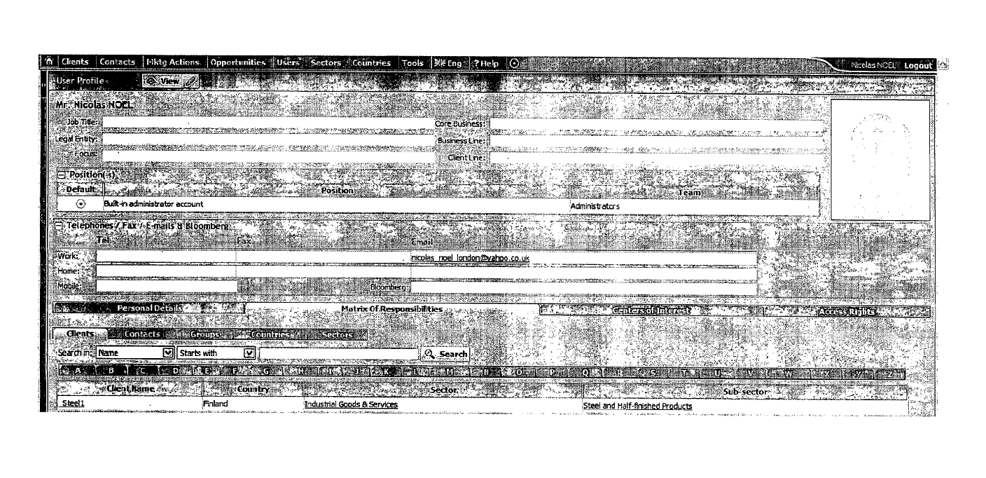

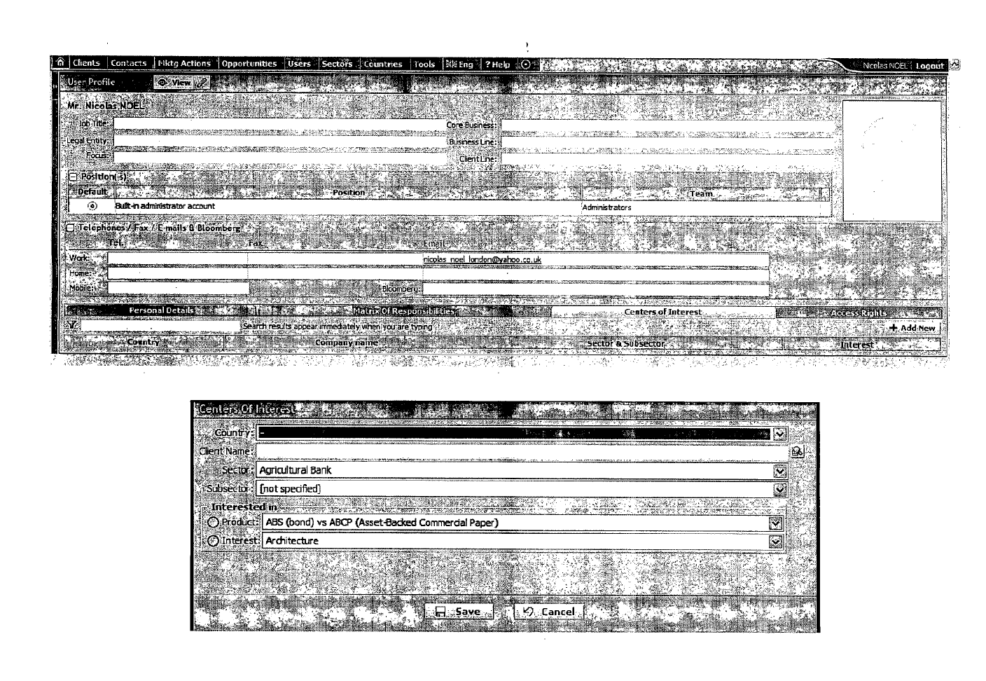

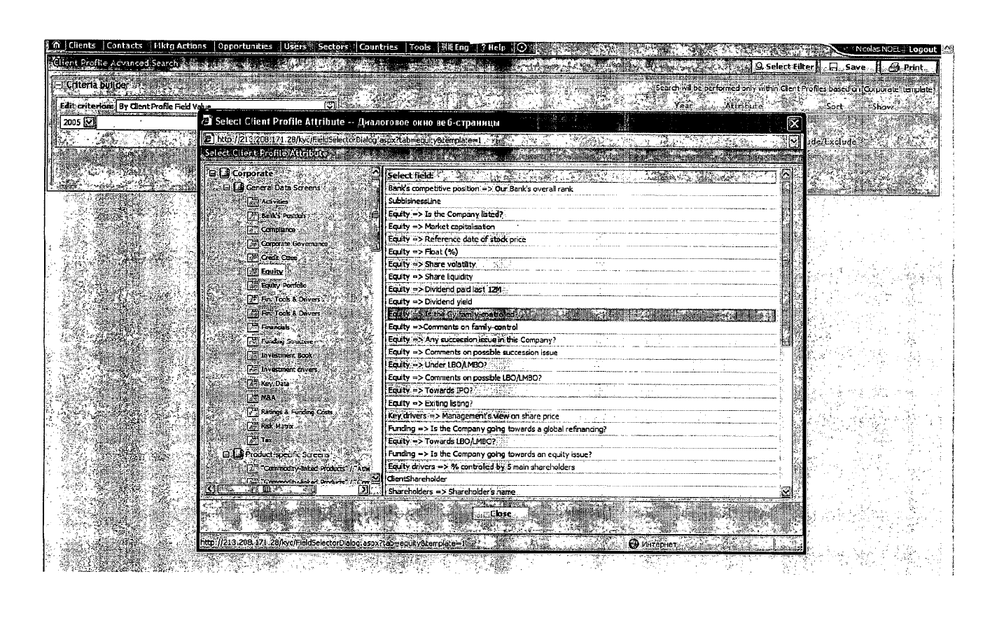

The User Profile is a series of Screens which provide the User's Contact Details as well as key information for instance on language skills (FIG. 19), the User's Matrix of Responsibilities (FIG. 20), the User's Centers of Interest and his/her Centers of Interest (FIG. 21).

A User, the User's Line Manager, or Administrator can edit Data in this User's Profile, Contacts Details sub-screen. In addition, the User can edit information in his Centers of Interest and, also, replace himself for another User in his Matrix of Responsibilities. The User's Line Manager can also replace the User for another User in his Matrix of Responsibilities and validate such Matrix. The User, his Line Manager and Administrator can view information in the User's Access Rights sub-screen, which displays combinations Country, Client, Sector & Sub-Sector that specify the User's Access Rights for Confidential and Semi-Confidential Data. All other Users can only view Data in the Contacts sub-screen and Matrix of Responsibilities but they cannot edit Data in the User's Profile. If the User is Line Manager himself, he can access “Manage Users” sub-screen by clicking on the corresponding tab and edit his subordinated Users. The complete information about the access rights to the User Profile Data (Write/Read/No access) are given in the table “User Profile access rights” in FIG. 18.

A User clicks on the link “My Profile” located in the Main Menu Screen or selects “My Profile” item from the Menu option “Users”. In addition, a User, the User's Line Manager or Administrator by performing a User's search and clicking on the corresponding User's name, which is presented as a link to the User's Profile, opens the User's Profile. In general, when a User's name is represented as a link to the corresponding User's Profile, clicking on the link displays the User Profile. In addition, a link to a User's Profile may be present in various parts of the System. Clicking on this link opens the corresponding User's Profile. For example, Contacts Screen of a Client Profile lists some User's Data including links to the User's Profiles. By clicking on these links it is possible to access the corresponding User's Profile directly from the Contacts Screen.

### Basic Flow

1. A General User, the User whose Profile is to be reviewed, the User's Line Manager or the Administrator accesses the User's Profile using one of the ways indicated in the Triggering Event(s) Section (see above).
2. The System displays “User Profile” Screen opened on the “Personal Details” sub-screen (tab “Personals Details”), see FIG. 19. For a General User, all the Data displayed are read-only. There are the following Data Fields that can be edited (fields that must have non-empty data are marked as required) by the User whose Profile is being reviewed, the User's Line Manager or Administrator (for the access rights to edit/view Data in the User's Profile, please refer to table “User Profile access rights” in the Section “Special Requirements”):

User Profile's screen entitled “Personal Details”: Civility (required); First Name (required); Last Name (required); Legal Entity (required); Core Business (required); Business Line (required); Client Line; Focus; Tel. (external) (required); Tel. (internal); Mobile Phone; Fax; Email (must be unique) (required); Secretary; Secretary's tel.; Secretary's email; Reference Language. The User Profile's screen entitled “Personal Details” also contains a section used to specify the User's schedule to receive messages from the Dispatch Center (see Section “Create Message to Dispatch”). It is possible to select one of the following options: Do not receive Messages from Dispatch Center; when Message was dispatched; Daily (with an option to specify Time)/Weekly (with an option to specify Day of Week and Time)/Monthly (with an option to specify Day of Month and Time).

Further, the Profile's screen has two drop-down boxes that can be used to create a table of the User's “language competencies” by selecting languages and the corresponding skill level (Basic Notions, Can be read, Fluent, Native Language).

The other four tabs in the User Profile Screen are used to access the “User's Matrix of Responsibilities” shown in FIG. 20. The “Centers of Interests” are shown in FIG. 21 and “Access Rights” are shown in FIG. 18. Depending on the User's Role, the access rights to edit/view the above-mentioned sub-screens are defined in the table “User Profile access rights” shown in FIG. 18.

The User can edit Data in his Centers of Interest (see section “Edit Centers of Interest”) and, also, replace himself for another User in his Matrix of Responsibilities (see section “Manage Matrix of Responsibilities”). If the User is a Line Manager himself, he can access “Manage Users” sub-screen by clicking on the corresponding tab, and edit his subordinated Users there. A Line Manager can also validate a Matrix of Competence of his subordinated Users. The User whose Profile is reviewed, the User's Line Manager or Administrator can view information related to the User's Access Rights for Confidential and Semi-Confidential Data in the User's Access Rights sub-screen.

The User, the User's Line Manager or Administrator edits the Data, which are accessible to them and, then, clicks on Save button in order to save the changes in the User's Profile. If any of the required fields have not been filled out the System displays the message that lists all the required fields that still need to contain some Data. (The message format: “-The {Field Name} field is required”, etc. for all the missing fields).

System displays message “Are you sure you want to save this User Profile?” If User, Administrator or Line Manager clicks OK, the changes in the Profile are saved. Alternatively, User, Administrator or Line Manager can click cancel to return to editing Data in the Profile. System saves the changes in the Database and displays the updated User Profile.

### Edit or Delete Record Centers of Interest

The User clicks on the “Edit entry” icon for the record in the Centers of Interest table (see FIG. 21). The System displays a dialog window that allows the User to select a) a Country, b) a Company name (by performing a standard Client search and selecting the Client of Interest), c) Sector or Sub-Sector and d) either Product or Interest from the corresponding drop-down boxes. This window displays the Data Parameters that exist in the selected record. User selects a new value(s) for any Data Parameter(s) the User wants to change and clicks on Save button. System closes this dialog window, updates the records and displays the updated Centers of Interest.

User clicks on the “Delete entry” icon next to a record in the Centers of Interest table. System displays a message “Delete this item?” User clicks OK. System deletes the selected record and displays the updated Centers of Interest. If the User clicks Cancel in the previous Step, System closes this message and the re cord is not deleted.

### Edit Centers of Interest

1) User clicks on the tab “Centers of Interest”.
2) System displays Centers of Interest sub-screen where the Data is organized in the table of four columns with the following headings: a) Country, b) Company name, c) Sector or Sub-Sector, d) Product or Interest. In addition, there are two icons on the left for each record in the table—one icon is used to edit the given record, and the other one—to remove the record. There is a button on top that is used to add a new record in the table.
3) User clicks “+Add New” button in order to add a new record in the Centers of Interest. The User can edit the existing record or remove a record from the Centers of Interest.
4) System displays a dialog window that allows the User to select a) a Country, b) a Company name (by performing a standard Client search and selecting the Client of Interest), c) Sector or Sub-Sector and d) Either Product or Interest from the corresponding drop-down boxes.
5) User selects any combination of the parameters and clicks Save in order to save a new record in his Centers of Interest. Alternatively, User can click on Cancel in which case this dialog window closes and the Data in the User's Centers of Interest are not changed.
6) System saves a new record in the Centers of Interest and displays the updated Centers of Interest.

### View Access Rights

The User, the User's Line Manager or Administrator can view the Access Rights sub-screen (see FIG. 18) in the User's Profile.
1) The User, the User's Line Manager or Administrator clicks on the tab “Access Rights” in the User Profile Screen.
2) System displays “Access Rights” sub-screen which is organized as a table with three columns: Country, Company Name, Sector & Sub-Sector. The records in the table specify the Access Rights of a given User for Confidential and Semi-Confidential Data. All records in the Access Rights table are Read only and can not be edited. If the User has been granted Access Rights for Confidential Data for a specific Client Profile this produces a record: Country (where the given Client is located) and Client (same as Company name) in the User's Access Rights table. Such Access Rights are granted by the Client Profile Owner.
If the User has been granted Access Rights for Semi-Confidential Data, this produces a record: Country and Sector in the User's Access Rights table. Such Access Rights are granted by the User's Line Manager.
If the User has been granted Access Rights for Confidential Data for a specific Country (Confidential documents attached to the Country Profile), this produces a record: Country in the User's Access Rights table. Such Access Rights are granted by the Country's Head of Territory or the Substitute User for the given Country.

### Modify Client Profile Data Repository

The Owner of a given Client Profile (either an Authorized Coverage Person or an Authorized Product/Sub-product Specialist) and/or an Overall Administrator can modify Data Parameters across the Database using the CPDR (Client Profile Data Repository).

The CPDR is the storage of Client Profile Data (Data Parameters with its attributes). The Owner cannot delete/edit already saved Data Parameters within the CPDR. The Owner can only add new Data Parameters.

Only Administrator is allowed to delete/edit Data Parameters in CPDR in case the Data Parameter is used nowhere in the Application. Once the Data Parameter is deleted from CPDR it will no longer appear on any Screen of the Application. At the same time, the history of this Data Parameter is still saved in the Database.

Data Parameters can be gathered by categories of business topics (e.g. “Accounts”, “Financials”, “Risks”, “Equity”, “Loans”, “Activity”, “Bank's competitive position”, the complete list to be provided by KYC and cannot be changed once delivered). Any Data Parameter can have only one category, and can be changed only by the Owner.

The basic flow is the following:
1) User gives command to modify CPDR from Main Menu of the Application.
2) System verifies the role of the User. If the User is authorized as Authorized Coverage Person or Authorized Product/Sub-product Specialist, then the System displays Screen “Modify CPDR” that allows only to add new Data Parameter (not edit/delete existing Data Parameters). Otherwise, if the User is authorized as Overall Administrator, then the System displays Screen “Modify CPDR” that allows add/edit/delete Data Parameters.
3) System displays Screen “Modify CPDR”. It includes the list of all Data Parameters within the CPDR (Field Name, Category, Data Type, Comments). By default, the Data is sorted by Category, and by Field Name within the same Category in alphabetical order.
4) If the User wishes to verify if the particular Data Parameter is already in CPDR (to avoid creating a duplicate under a terminology different, E.g. “sales” and “turnover”) see Alternative Flow “Search for Data Parameter”. User inputs the requested Field Name (or Partial Field Name) into the search field of “Modify CPDR” Screen. System performs Standard Search among all Field Name Data Parameters within CPDR. System displays the list of Field Names that match the requested criteria. Note: If the list of search results is empty it means that requested Data Parameter does not exist in the CPDR. It can be added into the CPDR.
5) User gives command to add new Data Parameter. If the User wishes to delete an existing Data Parameter, then the User selects the appropriate Data Parameter and clicks “Delete” button to delete existing Data Parameter from the CPDR. System checks if this Data Parameter is used somewhere within the Application. If the Data Parameter is used within the Application then the System displays notification message “This Data Parameter is used within the Application and can not be deleted”. The User clicks “OK” button, and the System reverts to step 3 of Basic Flow. If the Data Parameter is not used within the Application then the System displays notification message “Are you sure you would like to delete this data parameter?” If the User clicks “Cancel” the System reverts to step 3 of the Basic Flow, otherwise the User clicks “Yes”. System deletes existing Data Parameter from CPDR. System displays Screen “Modify CPDR” and reverts to step 10 of Basic Flow.
6) If the User wishes to edit an existing Data Parameter, in that case the User selects the appropriate Data Parameter and clicks “Edit” button to edit existing Data Parameter.
7) System displays Screen “Add/Edit Entry”.
8) User inputs/edits the following Data: Field Name (required); Data Type (required); Category (optional); and Comments (optional).
9) User clicks “Save” button to save changes of Data Parameter into the Database. If the User would like to cancel changes of Data Parameter, then the User clicks “Cancel” button to cancel changes of Data Parameter. System displays notification message “Are you sure you would like to cancel the changes of Data Parameter?” If the User clicks “Cancel” the System reverts to step 6 of the Basic Flow, otherwise the User clicks “Yes”. System displays screen “Modify CPDR”. Use case is terminated.
10) System validates Data format of each Data Field. If Data format is invalid, then System displays notification screen “Invalid Data Format”. This notification says which fields have invalid data format and what the correct one is. User clicks OK. System reverts to the last mode (corresponding screen in Edit Mode).
11) System saves changes in the Database and displays Screen “Modify CPDR”.

System logs corresponding Data into Change Log. System logs all Data in the Database, and System logs User actions.

### Confirm/Invalidate Temporary Data

It allows the Owner of a Client Profile to view and confirm the changes in the Client Profile Data Fields made after the last confirmation of the Data of this Profile. Also, it is possible to revert selected Fields to their old (last “confirmed”) values, i.e. to effectively undo all the changes made to this Profile after the last data confirmation. If the Fields are reverted to their old (last “confirmed”) values, the current values of these Fields will be lost.

If the changes in the Profile are confirmed, the current values for the Fields become the last “confirmed” values and it will not be possible to revert to the previous confirmed values for these Fields. The very first confirmed values are those, which are filled out during the given Client Profile creation by the Profile Owner.

1) Client Profile Owner selects the Edit mode of the given Client Profile and clicks on the appropriate button to open the Confirm Data Changes dialog. In the Edit mode the Client Profile becomes locked, i.e. no other User (than the Screen Owner) can edit any data in this Profile as long as the Profile remains in the Edit mode.
2) System displays the Confirm Data Changes dialog, which displays the Fields, their current values and the old or “last “confirmed” values. Only the Fields whose current values differ from their old (last “confirmed”) values are shown. A sign “+” in the second column indicates that the given Field had initially no value and has since then received some value, or a new row (even empty) has been added to a table. Similarly, a sign “−” indicates that the given Field has been stripped of its value and is blank, or a row (even empty) has been removed from a table. Also, the first column consists of the checkboxes to be used to undo the changes for the given Fields.

If the Client Profile Owner wishes to undo the changes for certain Fields, i.e. to revert to their last “confirmed” values, which are shown in the corresponding column, this is achieved through the following alternative flow: (a) Client Profile Owner checks the checkboxes for the Fields he/she wants to revert to their old “last confirmed” values shown in the column with the same heading; (b) Client Profile Owner clicks on the button “Revert Selected” in order to revert to the old “last confirmed” values of the selected Fields. If the Fields are reverted to their old “last confirmed” values, the current values of these Fields will be lost; (c) System displays a message: “Are you sure you want to revert to the old (“last confirmed”) values of the selected Fields? Please note that the current values of these Fields will be lost”; (d) Client Profile Owner clicks OK. If Client Profile Owner clicks Cancel, System reverts to the previous state of the Screen (immediately before “Revert Selected” was clicked”); (e) System changes the current values of the selected Fields to the old “last confirmed” values; (f) System removes the corresponding rows with the selected in previous steps Fields from the Confirm Data Changes dialog and recalculates Scores and Completeness for the given Profile (new values will be shown after the dialog is closed and the Client Profile is displayed in the View mode). If all Fields in the Confirm Data Changes dialog have been reverted to their old values (and, consequently, removed from the dialog), System closes the dialog and displays the Profile in the View mode. In this case, the Use Case ends. Assuming that some Fields are still present in the Confirm Data Changes dialog, Use Case continues at Step 2 of Basic Flow.

3) Client Profile Owner clicks on the button “Accept All” in order to confirm the changes for ALL Fields shown in the dialog. If the Profile Owner wishes to undo changes for certain Fields (i.e. revert to their previous confirmed values), see Alternative Flow “Revert Data Changes”. If the changes are confirmed, the current values for the Fields become the last “confirmed” values and it will not be possible to revert to the old (presently last “confirmed”) values for these Fields. If a Field consists of several subfields (for example, a row in a table contains several fields), it is possible either to confirm the changes or to revert to the pr shows a screen shot of previous values for the entire composite Field, rather than for individual subfields in this Field.
4) System displays the message: “Are you sure you want to confirm the changes for All the Fields shown in this dialog? Please note that after confirmation the current values will become the “last confirmed” ones and it will not be possible to revert to the old values.”
5) Client Profile Owner clicks OK. If Client Profile Owner clicks Cancel, System reverts to the previous state of the Screen (immediately before “Confirm All” was clicked).
6) System stores the current Values for the Fields then shown in the Confirmation Data dialog as the last “confirmed” values and closes the Confirm Data Changes dialog.
7) System displays given Client Profile in the View mode.

Within a client profile there is no differentiation between client data and product data. Many data parameters and related chosen data value appear on several screens, some belonging to general data screen while others belong to product screens. All users are able to edit data to which they have access. The editing they perform is always temporary data. Only the client profile owner who controls the business relationship with the client can validate the temporary data to make it become validated data. Even data initially edited by the client profile owner is preferably temporary data until he validates it. A table showing the relationship between client profile owners, product specialists, and client profile template owners and what they may amend is given in FIG. 4.

We now describe how scheduled filter scanning operates on client profiles and products to identify opportunities for sales to be made. It allows a general User to save Advanced Search Criteria as a Confidential (Private) Filter, so the Filter is stored in the System for future use.

1) User clicks on Save button from the Advanced Search (either Client or User) Screen.
2) User gives a Filter Name to the Filter (a compulsory action), selects option “Private”, and clicks on Save button. If User clicks on Cancel button, System closes the “Save Filter” Screen and displays the Screen from which this Use Case started.
3) System saves given Filter with: (i) the specified Filter Name; (ii) the User who saved and when he saved the Filter. If no Search Criteria was specified, see Alternative Flow “Empty Search Criteria”.

In order to schedule a filter scanning,

1. User clicks on the “Schedule Filter Scanning” link from the Main Menu Screen.
2. System displays “Filter Scanning” Screen.
3. User selects the Filter he/she wants to run by the System. Available Filters include: any of the Public Filters and any of this User's Private Filters.
4. System “locks” the Filter selected. Once selected to be used in Scanning, the Filter cannot be modified until the given Scanning Schedule was completed or terminated.
5. User specifies a Schedule for the System to perform Scanning with the given Filter (Scanning Schedule). It is possible to indicate Start date, End date, or both that defines the time range when Filter Scanning takes place. Other available options include:
Daily, or every N^{th} day. System runs Filter every day, or every N^{th} day.
Weekly, or every N^{th} week on one of the following days—Monday, Tuesday, Wednesday, Thursday, Friday, Saturday or Sunday (one to be selected). System runs Filter every week or every N^{th} week on a day specified.
Monthly—every D^{th} day of every M^{th} month. System runs Filter on every D^{th} day of every M^{th} month specified.
   Note: For data values: N, M are positive numbers, D ranges from 1 to 31. If a given month has fewer days than D, the Filter is run on the last day of the month.
Now—System runs the Filter immediately.
   Note: Let's consider the example. Today is Thursday. The User has indicated to run the Filter every Tuesday every second week. The first time the Filter will be run is next Tuesday, then in two weeks from the next Tuesday, etc.
   Note: At any point the User is able to click Cancel in order to cancel scheduling Filter Scanning.
   6. User selects the Recipients for the Filter Scanning Results. The System will then automatically populate the table with data for the Selected Users, as well as indicate that the User who performs Scanning can have access to these Recipients' Profiles. (Note, this table of Recipients should have, at least, one User—the Person who performs Scanning.) The Recipients Data to be shown in the table are the following: User First Name, User Last Name, Main Function, Email Address, and a link to access such User's Profile).
   7. User clicks on the appropriate button to initiate Filter Scanning task.
   8. System checks if the final list of Recipients is not empty. If System detects that the list is empty, it should display the warning message (“Please be aware that no Recipients for this Filter Scanning have been identified; to move to the next step please make sure that you have a non-empty list of Recipients”). It is not be possible to start Filter Scanning with an empty list of Recipients.
   9. System performs Filter Scanning according to the Scanning Schedule.
   10. System provides a comparison between the results of the current (most recent) Scanning and the results of the last (previous) Scanning and sends the Resulting messages to the Recipients after each Scanning.
   Note: If Scanning with a given Filter is run for the first time for the specified Schedule, the Resulting message will only contain the current results, as there were no previous results. Also, if the User selects option “Now” in the Scanning Schedule, there is by definition no periodicity for the given type of Scanning, and, therefore, the Resulting message will only contain the results for the current Scanning.
   11. System stores the results of the current Scanning for future comparison and deletes the old results.

Steps 9-11 are repeated with periodicity specified in the Scanning Schedule for the given Filter. After performing the last Scanning and releasing the last comparison Results in the given Schedule, or in the event of terminating this Scanning task, the Filter becomes unlocked and it can be modified by the appropriate User(s). In both such cases the Use Case ends.

### SUMMARY

Unlike existing CRM systems, this System is fully scalable in that it allows Users to include: (i) vertically, in each Product Family, as many Sub-products levels, and then Sub-sub-products levels—and henceforth, as deemed necessary by the Users; and (ii) horizontally, as many Products as necessary, gathered in as many Families of Products as deemed necessary by the Users. Likewise, an infinite number of Families of Client Profiles can be created.

The fully scalable properties of the System are illustrated in FIG. 3.

Unlike existing CRM systems, this System is neither superficial nor too detailed in terms of the information which it aims to gather. Indeed, for each level of required details of information, the right balance is structurally struck, because the methodology followed calls for a step-by-step “zoom” approach to gradually “identifying=>validating=>marketing” a given business opportunity (i.e. selling a Product/Sub-product to a specific Client in/at a specific context/time). The Users are only asked detailed questions once the 1st level of analysis (the Product Screen) has confirmed there was a potential opportunity for this Product or specific Sub-products attached to this Product. Likewise, even more specific and detailed questions are only asked once the 2nd level of analysis (the Sub-product Screen) has confirmed there was a potential opportunity for this Sub-product. The Opportunity Scoring (described hereafter) allows Users to know whether they should or should not continue to gather specific Screening Criteria in relation to a specific Product or Sub-product. This “zoom” approach is greatly facilitated by the Criticality Mark (described above) which allows each Screen Owner to indicate to Users what are the most critical Data to be gathered for each Screen. Both the Opportunity Scoring and the Criticality Mark allow Product Specialists to efficiently and in real-time convey to the Coverage Persons the right guidelines and information as to the most relevant Screening Criteria. No traditional face-to-face dialogue or training could be capable of achieving this convergence, on a scale and within a response time even remotely similar.

Unlike existing CRM systems, this System is not static, but is a living product being constantly kept up to date of Product evolutions. This is first achieved by allocating each Product (Sub-product, and Sub-sub-product, etc) Screen to a dedicated Product Specialist. In a second step, each such Product Screen Owner is put in a position and asked to fine-tune his/her Product Screen(-s) by adjusting the Data Parameters (adding, deleting and/or amending), the Criticality Marks and the Opportunity Scoring (what we refer to as the “Decentralized Fine-tuning”). This customizability can be achieved by each Product Screen Owner, without the need to resort to an in-house (or external) software programmer. By amending one Product Screen, all the corresponding Product Screens in the same Families of Clients are automatically amended. The Decentralized Fine-tuning allows the Application to stay dynamically in tune with the evolutions in the most relevant Screening Criteria, as those may evolve along with the legal, tax, regulatory and economic environments, and any other factors.

Unlike existing CRM systems, the System is specifically designed to ensure that Users adopt a co-operative behavior, with the main means of achieving that being two virtuous circles: (i) by Fine-tuning the Data Parameters, the Criticality Marks and the Opportunity Scoring, the Product Specialists certainly give away their proprietary Screening Criteria, but receive—in return for this decentralization of screening criteria—many more opportunities to sell their Products and Sub-products than they would have had otherwise if the Coverage Persons had not been provided via the Application with the Screening Criteria; (ii) by using the Application regularly, each User ensures that his/her Centers of Interest appearing in their User Profile (each as defined hereafter) in terms of Clients, Products, Sectors and Countries is constantly kept up-to-date, and this in turn allows each User to receive a flow of information chosen to match his/her Centers of Interest. These two virtuous circles ensure that the Application stands the highest chance of being properly maintained and frequently used.

Unlike existing CRM systems, the System maximizes synergies between: (i) a web of interacting Profiles, namely the Client Profile, Sector and Sub-sector Profiles, the Country Profile, the Benchmark & Credentials Profiles, the User Profiles, and the Peer Group; (ii) a series of Transversal Tools, namely first the Filter Scanning used to detect marketing opportunities across the Client Profiles, second the Targeted Press Reviews reflecting User's Centers of Interest as inferred from their use of the System and from their declared Centers of Interest and Matrix of Responsibilities, third the Advanced Search which—in addition to allowing Filter Scanning and Targeted Press Reviews—provides a drill down functionality allowing an extensive data mining; and (iii) a 2^{nd} Generation CRM which is deeply embedded in the System via numerous two-way bridges to and from the various Profiles (E.g. Client—Opportunity—User/Contact, Sector & Country), and a Knowledge Database which constitutes a collaborative knowledge database extensively hyperlinked with the Profiles, Transversal Tools and the 2^{nd} Generation CRM.

In order to facilitate access to required information for each User the System offers a series of “My Views” which relate to all main objects (Clients, Call Reports, Sectors, Countries, etc.). All such Views are described below, in same order as they appear in the side-menu.

Selecting “My Alerts” option displays alerts related to some important events the given User should be aware of based on the given User's Role(s) in the System. The alerts can be pre-filtered and displayed for the events related to: Opportunities, Call Reports, and Client Profiles, and Contacts. The most recent alerts are shown on top, all alerts are shown with indicating the time and date when the relevant events took places. There is a functionality to search for the Alerts among those displayed that match the search criteria.

Selecting “My Clients” displays all Client Profiles for which the given User is assigned any of the following Roles: Client Coverage (Relationship Manager 1, Business Analyst 1, Relationship Manager 2, Business Analyst 2), Product Specialist, other Roles in the Client (Legal, Human Resources, Tax, etc), or if the User covers any Contact in the given Client. The User's Primary Role related to the given Client is displayed in the column “Primary Coverage Role(-s)”. The following Clients' data are displayed: Client Name, Country, Sector, Sub-sector, Group Name, Primary Coverage Role(-s).

Selecting “My Team's Clients” (located under My Clients) displays all the Client Profiles which are listed in the User's team members' “My Clients” lists (including the User himself).

Selecting “My Manager View on Clients” lists all Client Profiles which are listed in the User's Team members (including the User himself), as well as members of all the Teams in the hierarchy below the given User's Team (i.e. subordinated to the User's Team) “My Clients” lists. On top of each screen there is functionality to search among the relevant set of Client Profiles (“My.”, “My Teams . . . ” or “Manager View . . . ”) based on some specific search criteria.

Selecting “My Contacts” displays all Contacts covered by the given User. The following fields for each Contact are displayed: Contact Name, Client (associated with the given Contact), Job Title, Work Tel., Work Email, Coverage Role (i.e. the User's coverage Role for the given Contact), Coverage Product(-s) (i.e. the Bank Products the User covers this Contact with). Similarly, on top of the screen there is a functionality to search for the Contact(s) that match some specific search criteria.

Selecting “My Marketing Actions” displays all Call Reports and Phone Logs for which the given User is the Creator (i.e. the User who has created the corresponding Report or the Phone Log), the Originator or one of the Participants. It is possible to display only Call Reports or Phone Logs or both types by selecting the appropriate option. The User can search for the Marketing Actions that match the selected search criteria.

Selecting “My Team's Marketing Actions” displays all Call Reports and Phone Logs in which the User or any User's Team member(s) is(are) among the Participants of the given Call Report or a Phone Log.

Selecting “My Manager View on Marketing Actions” displays all Call Reports and Phone Logs in which the User, any User's Team member(s), as well as a member of any Teams in the hierarchy below the User's Team is(are) among the Participants of the given Call Report or a Phone Log.

Selecting “All Call Reports (or Phone Logs) on My Clients” displays all Call Reports (or Phone Logs) in which one or several Client(s) the given Report or Phone Log is written for belongs to the User's “My Clients” list.

Selecting “All Call Reports (or Phone Logs) on My Team's Clients” displays all Call Reports (or Phone Logs) in which one or several Client(s) the given Report or Phone Log is written for belongs to the User's or any User's Team member “My Clients” list(s).

Selecting “All Call Reports (or Phone Logs) on My Manager View on Clients” displays all Call Reports (or Phone Logs) in which one (or several) Client(s) the given Report or Phone Log is written for belongs to the User' or any User's Team member “My Clients” list(s), or such Client(s) belongs to “My Clients” lists of any User from the Team(s) in the hierarchy below the given User's Team(s).

Selecting “All Call Reports on my Opportunities” displays all Call Reports that are linked to, at least, one Opportunity that also belongs to the User's “My Opportunities” list (i.e., the Opportunity for which the given User belongs to the Opportunity team).

Selecting “All Call Reports on my Team's Opportunities” displays all Call Reports that are linked to, at least, one Opportunity that also belongs to the User or any User's Team member's “My Opportunities” list(s) (i.e., the Opportunity for which the given User or any Team member belongs to the Opportunity team).

Selecting “All Call Reports on my Manager View on Opportunities” displays all Call Reports that are linked to, at least, one Opportunity that also belongs to the User or any User's Team member's, or any User in Team, which are directly below the given User's Team, “My Opportunities” lists.

Selecting “My Opportunities” displays a list of all Opportunities for which the given User is present in the Opportunity team—either as an Owner or as a Participant. The following data fields are displayed: Heading (of the Opportunity), Client (the Opportunity is related to), Product(-s), Sale Stage, Privacy, Probability of Success, Amount of the Opp., Currency, Last updated, Closing Date (estimated or actual). The User can search for the relevant Opportunities contained in the displayed list using some specific criteria.

Selecting “My Team's Opportunities” displays all Opportunities in which the given User or any User's Team member belongs to the Opportunity Team.

Selecting “My Manager View on Opportunities” displays all Opportunities in which the given User, any User's Team member, or any User in the Team in the hierarchy below the given User's belongs to the Opportunity Team.

Selecting “My Filters” displays the Filters (i.e., Advanced Searches for Users or Clients), which were created and saved by the given User. The following data are displayed: Title (i.e., Name of the Filter), Type (Public or Private), Search For (Clients or Users).

Selecting “My Scheduled Filters” displays all the Filters, which have been scheduled to run in the System by the given User (some of these Filters may have been created by other Users).

Selecting “My Sectors” displays a list of Sectors, for which the User is a) the Head of the given Sector, b) the Substitute Head of the Sector, or c) a Sector Specialist. The following data are displayed: Sector/Sub-sector, n (number of Clients in the given Sector), Country (of the Top Client), Top Client (by its Turnover), and Turnover (of the top Client).

Selecting “My Countries” displays a list of Country Profiles for which the User is the Head of Territory or the Substitute Head of Territory. The following data are displayed: Country Code, Country Name, and the User's Role in this Country.

Selecting “My Teams” option takes the User to this User Profile, which is shown in the right pane whereas the left pane displays the User's Team members. It is also possible to access other Team(s) in which the given User has been assigned Position(s) by selecting the corresponding Team Name in the drop-down box on top of this pane. (By default, the User's default Team is shown).

1. A computer-implemented customer relationship management (CRM) system for use by a plurality of users, the system comprising:
a plurality of client profiles, each client profile including both a plurality of general dimension which describe non-product specific characteristics of a client associated with the respective client profile, and a plurality of product screens, each client profile comprising a plurality of data parameters, each data parameter having a plurality of data values assignable to it;
wherein the system is configured to provide each user of the plurality of users with access to at least some of the data parameters for a client profile of the plurality of client profiles, via a computer screen, and to permit each user to modify the plurality of data values assignable to each of the at least some data parameters;
wherein the system is further configured to permit each user to save any modified data values as temporary data for the client profile; and
wherein the system is further configured to permit at least one user of the plurality of users to store, in a computer readable medium, the modified data values as updated data values for a corresponding data parameter of the at least some data parameters.

2. A computer-implemented customer relationship management (CRM) system for use by a plurality of users, the system comprising:
a plurality of product profiles, each product profile comprising a plurality of data parameters, each data parameter having a plurality of data values assignable to it;
wherein the system is configured to provide each user of the plurality of users with access to at least some of the data parameters for a product profile of the plurality of product profiles, via a computer screen, and to permit each user to modify the plurality of data values assignable to the at least some data parameters to which that user has access, and to save any modified data values as temporary data for the product profile; and
wherein the system is further configured to permit at least one user of the plurality of users to store, in a computer readable medium, the modified data values as updated data values for a corresponding data parameter of the at least some data parameters.

3. The CRM system according to claim 1, further comprising, for at least one client profile of the plurality of client profiles, a criticality mark assigned to a data parameter category associated with at least one data parameter of the plurality of data parameters.

4. The CRM system according to claim 1, further comprising at least one of a risk score and an opportunity score associated with at least one data parameter of the plurality of the data parameters.

5. The CRM system according to claim 4, further comprising means for deriving a total risk score from all the risk scores associated with the plurality of data parameters for at least one client profile of the plurality of client profiles.

6. The CRM system according to claim 5, further comprising means for deriving a total opportunity score from all the opportunity scores associated with the plurality of data parameters for at least one client profile of the plurality of client profiles.

7. The CRM system according to claim 27, further comprising means for deriving a total opportunity score from all the opportunity scores associated with data parameters, for at least one product profile of the plurality of client profiles.

8. The CRM system according to claim 1, wherein the plurality of data parameters for each client profile includes data parameters associated with the client associated with the respective client profile, and data parameters associated with at least one product sellable to the client.

9. The CRM system according to claim 8, wherein the data parameters associated with the client are arranged in at least one general screen of the plurality of general screens for display to a user; of the plurality of user; and
wherein the data parameters associated with the at least one product are arranged in at least one product screen of the plurality of product screens for display to the user.

10. The CRM system according to claim 9, wherein at least one data parameter appears over multiple screens of at least one of the plurality of general screens and the plurality of product screens;
wherein the system is configured to permit the at least one data parameter to be modified from each of the multiple screens; and
wherein the system is configured to automatically align a confidentiality level attached to the at least one data parameter to a highest confidentiality level assigned by an authorized user.

11. The CRM system according to claim 9, wherein the system is further configured to, each time a user views a screen available for display, derive a total score is for each type of score associated with the client or product to which the screen relates.

12. The CRM system according to claim 11, wherein the system is further configured to derive a total risk score each time one of the plurality of general screens is viewed.

13. The CRM system according to claim 11, wherein the system is further configured to derive a total opportunity score each time one of the plurality of general screens is viewed.

14. The CRM system according to claim 11, wherein the system is further configured to derive a total opportunity score each time one of the plurality of product screens is viewed.

15. The CRM system according to claim 11, wherein the system is further configured to derive a total criticality score each time one of the plurality of general screens is viewed.

16. The CRM system according to claim 8, further comprising means for filtering opportunity scores and the data parameters associated with the client to determine which clients are best suited to marketing of a particular product.

17. The CRM system according to claim 4, wherein the plurality of data parameters of each client profile includes data parameters associated with client executable deals; and
wherein the system is configured to interface the data parameters associated with the client executable deals are with a corresponding opportunity score.

18. The CRM system according to claim 27, each product profile further comprises a subsidiary profile providing information with respect to client executable product deals, for clients in one of a same country and a same sector, the information being interfaced with the corresponding opportunity score.

19. The CRM system according to claim 2, wherein each product profile further comprises a subsidiary profile providing free text information with respect to a preselected topic.

20. The CRM system according to claim 1, wherein each client profile further comprises a subsidiary profile providing free text information with respect to a preselected topic.

21. The CRM system according to claim 1, further comprising client marketing strategy information accessible from a client profile of the plurality of client profiles.

22. The CRM system according to claim 1 or 2, further comprising means for displaying contextually-targeted advertisements and information to a user of the plurality of users when the user is viewing a first screen of the plurality of general screens or product screens, content of the advertisements and information being related either (i) to one of the client, product, country and sector to which the first screen relates, or (ii) to the user's centers of interest, which are declared by the user or derived from the user's actual use of the system.

23. A computer-implemented customer relationship management (CRM) system comprising:
a plurality of client profiles, each client profile comprising a first plurality of data parameters, each data parameter of the first plurality of data parameters having a first plurality of data values assignable to it, and an identity of at least one coverage person authorized to validate the first plurality of data values;
a plurality of product profiles each product profile comprising a second plurality of data parameters, each data parameter of the second plurality of data parameters having a second plurality of data values assignable to it, and an identity of at least one product specialist authorized to assign data parameters of the second plurality of data parameters to the respective product profile;
wherein the system is configured to permit users of the system to make temporary modifications to first and second pluralities of data values, and
wherein the system is further configured to permit only the coverage person to validate the temporary modifications.

24. The computer-implemented customer relationship management system according to claim 23, wherein the system further comprises new data parameters in a client profile of the plurality of client profiles, and comprising:
confidentiality scores assigned to the new data parameters by a client profile template administrator and at least one client profile owner; and
criticality, opportunity and risk scores assigned to each new data parameter by at least one of each client profile owner, and by a product specialist owner, across a family of client profiles.

25. A method for operating a computer-implemented customer relationship management system for use by a plurality of users, the method comprising steps of:
(i) creating a plurality of client profiles and product profiles, each client profile comprising a plurality of data parameters, each data parameter having a plurality of data values assignable to it;
(ii) permitting each user of the plurality of users to access at least some of the data parameters for a client profile of the plurality of client profiles and to modify the plurality of data values assignable to the at least some data parameters;
(iii) storing modified data values as temporary data; and
(iv) permitting at least one user of the plurality of users to permanently store the temporary data as validated data on a computer readable medium.

26. A method for operating a computer-implemented customer relationship management system comprising a plurality of client profiles, the method comprising steps of:
creating the plurality of client profiles, each client profile comprising a plurality of data parameters, each data parameter having a first plurality of data values assignable to it;
for each client profile, designating a creator of the client profile as a coverage person authorized to validate the plurality of data values assigned to each of the plurality of data parameters of the client profile;
for each client profile, assigning at least one product profile to the client profile, each product profile having a plurality of data parameters, each data parameter having a second plurality of data values assignable to it,
designating a product specialist to each product profile, the product specialist being authorized to assign data parameters to the respective product profile;
permitting a user to make temporary modifications to the first and second pluralities of data values; and
permitting only the coverage person to validate the temporary modifications.

27. The CRM system according to claim 2, further comprising at least one of a risk score and an opportunity score associated with at least one data parameter of the plurality of the data parameters.

28. The CRM system according to claim 2, further comprising client marketing strategy information accessible from a product profile of the plurality of product profiles.
